(19) United States
(12) Patent Application Publication
(10) Pub. No.: US 2017/0064926 A1
(43) Pub. Date: Mar. 9, 2017

(54) INTERACTIVE PET ROBOT AND RELATED METHODS AND DEVICES

(71) Applicant: PulsePet, LLC, Dallas, TX (US)

(72) Inventor: Santiago Gutierrez, Dallas, TX (US)

(21) Appl. No.: 15/256,274

(22) Filed: Sep. 2, 2016

Related U.S. Application Data
(60) Provisional application No. 62/214,697, filed on Sep. 4, 2015.
(60) Provisional application No. 62/336,279, filed on May 13, 2016.

(51) Int. Cl. A01K 15/02; A01K 29/00; H04N 5/225; G05B 19/042; G06F 3/16; H04W 4/00; A01K 5/00; G05B 19/409

(52) U.S. Cl. CPC A01K 15/025; A01K 5/00; A01K 29/005; G05B 19/409; G05B 19/042; G06F 3/16; H04W 4/005; H04N 5/225; H04W 84/12

(57) ABSTRACT

A pet toy is configured for interaction with an animal. The pet toy includes a core, a shell, and at least one camera. The core includes at least one processing device configured to control one or more operations of the pet toy. The core also includes at least one transceiver configured to transmit to and receive information from a wireless mobile communication device, where the received information includes control information associated with movement of the pet toy. The core further includes at least one motor configured to move the pet toy around a substantially planar surface based on the control information received from the wireless mobile communication device. The shell is durable, removable, and is configured to at least partially surround and protect the core. The at least one camera configured to capture still or video images of the animal while the animal interacts with the pet toy.

### CROSS-REFERENCE TO RELATED APPLICATIONS AND PRIORITY CLAIM

This application claims priority under 35 U.S.C. §119(e) to:

U.S. Provisional Patent Application No. 62/214,697 filed on Sep. 4, 2015 and entitled “INTERACTIVE PET ROBOT AND RELATED METHODS AND DEVICES”; and

U.S. Provisional Patent Application No. 62/336,279 filed on May 13, 2016 and entitled “SMART BONE.”

The contents of both provisional applications are hereby incorporated by reference in their entirety.

### TECHNICAL FIELD

This disclosure relates generally to interactive pet toys. More specifically, this disclosure relates to an interactive pet robot and related methods and devices.

### BACKGROUND

Many pet owners are routinely forced to leave their pets alone at home for extended periods. For example, pets are often left unattended while their owners are at work or running errands. Even when pet owners are home, they may be unable to attend to their pets. For example, they may be tired, busy with housekeeping, or working from home. During such times, the pets often simply play with one or more non-interactive pet toys and can quickly lose interest in those toys. Also, during such times, the owners typically cannot interact with their pets and have no idea what their pets are doing. In some cases, owners install webcams or other devices to monitor their pets, but these devices remain in fixed positions and typically offer no way for owners to interact with their pets.

### SUMMARY

This disclosure provides an interactive pet robot and related methods and devices.

In a first embodiment, a pet toy configured for interaction with an animal is provided. The pet toy includes a core, a shell, and at least one camera. The core includes at least one processing device configured to control one or more operations of the pet toy. The core also includes at least one transceiver configured to transmit to and receive information from a wireless mobile communication device, the received information comprising control information associated with movement of the pet toy. The core further includes at least one motor configured to move the pet toy on a substantially planar surface based on the control information received from the wireless mobile communication device. The shell is configured to at least partially surround and protect the core, and the shell is formed of a rigid plastic material. The shell is configured to be removable from the pet toy without damage to the core. The at least one camera is configured to capture still or video images of the animal while the animal interacts with the pet toy.

In a second embodiment, a method includes receiving, by at least one wireless transceiver, information from a wireless mobile communication device. The received information includes control information associated with movement of a pet toy configured for interaction with an animal. The pet toy includes a core, a shell, and at least one camera. The method also includes controlling, by at least one processing device, at least one motor to move the pet toy on a substantially planar surface based on the control information received from the wireless mobile communication device. The method further includes capturing, by the at least one camera, still or video images of the animal while the animal interacts with the pet toy. The core includes the at least one processing device, the at least one transceiver, and the at least one motor. The shell at least partially surrounds and protects the core, where the shell is formed of a rigid plastic material. The shell is configured to be removable from the pet toy without damage to the core.

In a third embodiment, a non-transitory computer readable medium contains instructions that, when executed by at least one processing device, cause the at least one processing device to receive information from a wireless mobile communication device, the received information comprising control information associated with movement of a pet toy configured for interaction with an animal, the pet toy comprising a core, a shell, and at least one camera. The instructions also cause the at least one processing device to control at least one motor to move the pet toy on a substantially planar surface based on the control information received from the wireless mobile communication device. The instructions further cause the at least one processing device to control the at least one camera to capture still or video images of the animal while the animal interacts with the pet toy. The core includes the at least one processing device, at least one transceiver, and the at least one motor. The shell at least partially surrounds and protects the core, the shell formed of a rigid plastic material, the shell configured to be removable from the pet toy without damage to the core.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an exploded view of an example interactive pet robot according to this disclosure;

FIGS. 2 and 3 illustrate major components of a core of the interactive pet robot of FIG. 1 according to this disclosure;

FIG. 4 illustrates a more detailed view of one embodiment of the core according to this disclosure;

FIGS. 5 through 8 illustrate major components of a shell of the interactive pet robot of FIG. 1 according to this disclosure;

FIG. 9 illustrates different views of an alternative design for the shell according to this disclosure;

FIGS. 10 and 11 illustrate major components of wheels of the interactive pet robot of FIG. 1 according to this disclosure;

FIG. 12 illustrates different views of the interactive pet robot of FIG. 1 with a tail attached according to this disclosure;

FIG. 13 illustrates one example of a tail;

FIGS. 14 through 16 illustrate example steps for assembling the components of the interactive pet robot of FIG. 1 according to this disclosure;

FIG. 16A illustrates an exploded view of the interactive pet robot with the core of FIG. 4 according to this disclosure;

FIG. 17 illustrates the interactive pet robot of FIG. 1 changing directions according to this disclosure;

FIG. 18 shows an example of a family using a mobile device to control an example instance of the interactive pet robot according to this disclosure;

FIG. 19 illustrates an example hierarchical framework for an operational profile according to this disclosure;

FIG. 20 illustrates an example screen from a mobile app for use with the interactive pet robot of FIG. 1 according to this disclosure; and

FIG. 21 illustrates an example device for performing functions associated with operation of an interactive pet robot according to this disclosure.

### DETAILED DESCRIPTION

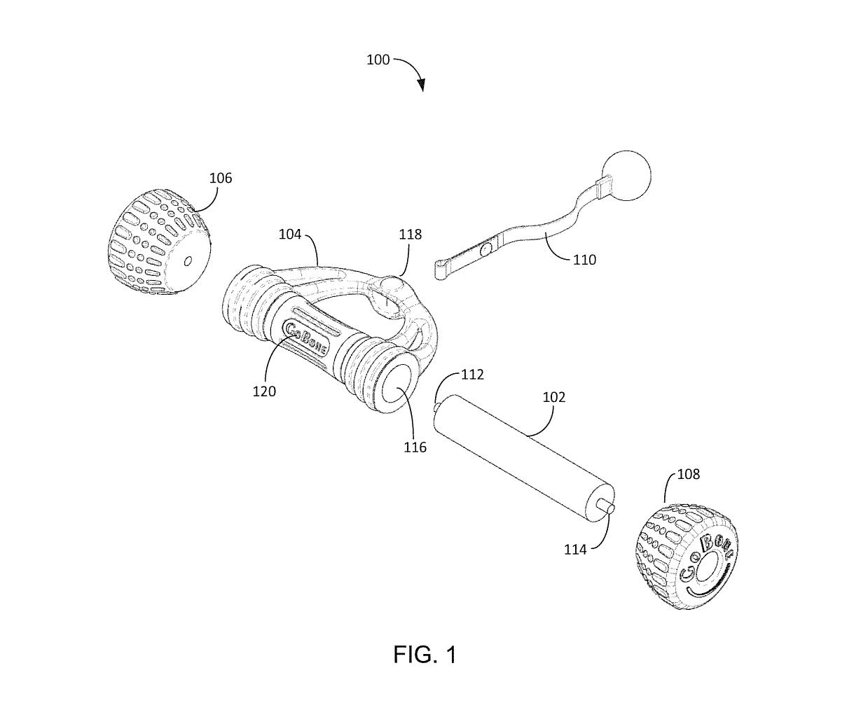

FIGS. 1 through 21, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Note that in the following description, reference is routinely made to an interactive pet robot that is used by a dog or cat. However, this disclosure is not limited to interactive pet robots for use with dogs or cats. In general, the interactive pet robots described in this patent document could be used by any suitable animal.

Definitions

Terms defined in this section are used throughout this patent document.

Airtime—a period of time when an interactive pet robot is suspended in the air, such as when it is in an animal's mouth.

Animal Sizes—different categories of animal sizes, such as small (up to 15 pounds), medium (15-40 pounds), large (40-80 pounds), and extra large (over 80 pounds).

Breed Characteristics Database (BCD)—a database that contains

General Animal Characteristics (GAC) information. The BCD can reside locally or remotely, such as “in the cloud.” The BCD could identify various characteristics for different breeds of animals, such as: energy level, exercise needs, prey drive, intelligence, intensity, potential for mouthiness, and potential for weight gain. The BCD can alternatively or additionally identify any other animal characteristics.

Chain—a combination of one movement with another movement.

Characteristic Score (CS)—a score assigned to a specific characteristic of an animal, such as on a scale of 1-5 (least to most).

Collar Clip—a wireless device that clips onto an animal's collar to determine one or more characteristics of the animal, such as location or activity level.

Edible—anything edible that can be inserted into or placed on an interactive pet robot's core or its accessories, such as food, treats, or peanut butter.

General Animal Characteristics (GAC)—a set of characteristics for each breed of animal scored on a scale, such as from 1-5 (lowest to highest). The score is known as the General Animal Characteristics Score (GACS).

Individual Animal Characteristics (IAC)—a set of characteristics that define an animal. This data can be provided by a user and can include information such as animal name, age, weight, breed, and any medical conditions.

Motor Speed—a percentage of a maximum duty cycle for a motor in an interactive pet robot.

Operating Profile (OP)—a profile that dictates or describes the operation or behavior of an interactive pet robot.

Priority Levels (P#)—information that dictates a priority of different characteristics.

Session—the period of time that begins when an interactive pet robot is placed in front of an animal and ends when the interactive pet robot runs out of power or is turned off by a user.

User—a human operator of the interactive pet robot.

Overview

This patent document describes an interactive pet robot for dogs, cats, or other animals. Various features of the interactive pet robot include automation, connectivity,interactivity, personalization customization, durability, and input/output (I/O). In some embodiments, the interactive pet robot can be configured to operate independent of user input. A user does not have to be involved for the interactive pet robot and the animal to interact with one another. The interactive pet robot can interact with the animal on its own. In some embodiments, the interactive pet robot may have the ability to map the space it operates in via a camera, one or more sensors, software, or a combination of these. The mapping can be performed to learn the layout of the operating space, avoid obstacles, and/or locate objects such as a recharge station where the interactive pet robot can recharge itself autonomously. The interactive pet robot may also adapt and optimize its operation for a specific animal. The camera, sensor(s), and/or software may also be used to learn the animal's individual characteristics, such as personality and interaction style.

The interactive pet robot disclosed here offers a number of connectivity options. In some embodiments, the user can connect to the interactive pet robot wirelessly, such as by using a smart “app” on the user's mobile smartphone or tablet computer, using a web-based portal, or using an application executed on the user's computing device. The interactive pet robot can communicate via wireless technology, such as WI-FI or BLUETOOTH. Connections and interactions can be local (such as while the user is home or otherwise within a personal area network wireless range of the interactive pet robot) or remote (such as while the user is away from home or otherwise not within the personal area network wireless range of the interactive pet robot). Example types of interactions can include controlling the interactive pet robot's movements, upgrading its firmware, and changing its operating characteristics. The interactive pet robot could also connect to the Internet and possibly communicate with other wireless products in the “Internet of Things” (IoT) ecosystem. The interactive pet robot may further be managed by other devices, such as a wireless router station that is capable of managing a network of products and connecting the network to the Internet. The wireless router station or the interactive pet robot may include a camera, speaker, and microphone so that a user may connect to a base station or the interactive pet robot from a remote location (such as via a WAN) and speak to his or her pet, hear the pet, and control the interactive pet robot. The user could also capture and share photos and videos of his or her pet(s) playing with the interactive pet robot, such as sharing via text message, social media, or other channels using the app. In addition, the interactive pet robot can send real-time notifications to the user, such as notifications to update the user on usage statistics, when the interactive pet robot and animal interact, when the animal is near the interactive pet robot, and when the interactive pet robot's battery is low.

The interactive pet robot disclosed here is highly interactive. In some embodiments, the interactive pet robot can include one or more interchangeable accessories that are chewable and that are replaceable once consumed or when desired. For example, the accessories could be made of plastic, rubber, synthetic rubber, or polyester fabric textile. The interactive pet robot can make sounds and “sing” by varying the duration that one or more motors are active and varying the PWM duty cycle (pitch or frequency). Sounds can call attention to the interactive pet robot and can serve as an accessibility feature for animals with vision impairments.

The interactive pet robot may also use light emitting diodes (LEDs) or other lights inside its core/housing for lighting. Lighting can amplify the interactive pet robot's personality and denote the product status (such as charging or wirelessly connected). Large numbers of color combinations may be possible.

The interactive pet robot can also interact with its environment via sensors. For example, an accelerometer, gyroscope, compass, and/or inertial measurement unit (IMU) can detect a position or orientation of the interactive pet robot, help orient the interactive pet robot, and alert the interactive pet robot when collisions occur and when the interactive pet robot is picked up or played with. Infrared, ultrasonic, or other sensors could be used to help with collision avoidance. A charge-coupled device (CCD) or other imaging sensor and a microphone on the interactive pet robot can be used to capture information, and speakers on the interactive pet robot can allow two-way remote communication between the user and the animal. For example, the interactive pet robot could include a video camera to capture and stream video, a microphone so the user can hear the animal and the surrounding environment, and a speaker so the user can speak to the animal.

The interactive pet robot can have wheels or other locomotive components so that the interactive pet robot can move around on the ground with varying acceleration, speed, and direction. When the interactive pet robot moves forward or backward, the rear portion of the interactive pet robot could make contact with the ground to prevent its core/shell from spinning in place. The user can place edibles inside the wheels or a shaft, and the edibles can be distributed when the interactive pet robot is in motion. Movement allows the interactive pet robot to play games with animals autonomously, such as chase, hide and seek, and fetch. In some embodiments, the user can take part in games like fetch with the interactive pet robot.

The interactive pet robot offers options for personalization. In some embodiments, users can provide individual animal characteristics, such as age, breed, medical conditions, and weight, for one or more animals that can interact with the interactive pet robot. These characteristics can be combined with a database of general animal characteristics to create a custom operational profile for each animal. One or more algorithms can use the animal characteristics to enable the interactive pet robot to adapt to individual animals. Such algorithms can be executed internally by one or more processors built into the interactive pet robot. Additionally or alternatively, the algorithms can be executed externally, such as in the cloud, and then interaction operations can be downloaded to the interactive pet robot.

The interactive pet robot is highly customizable. Various accessories for the interactive pet robot (such as shells, wheels, and tails) can be interchanged and replaced. Accessories may be available in different sizes, materials, shapes, colors, textiles, and textures. An animal's size and the intended area of use can be taken into consideration when the user chooses accessories. For example, larger wheels enable operation in outdoors terrain such as grass and gravel.

The interactive pet robot is durable. In some embodiments, the interactive pet robot's core may be protected against ingress by a housing, shell, wheels, and other accessories. This can help to prevent the animal from penetrating the core. Accessories may be consumable and could last a few weeks to a few months, depending on the user and animal's use habits. The interactive pet robot can be used indoors or outdoors. The materials forming the interactive pet robot can be durable in order to keep the animal safe but light enough so that the interactive pet robot can be carried around by the animal.

With respect to I/O, depending on the embodiment, the interactive pet robot may or may not include physical buttons or switches on its external surfaces. For example, the user may be able to turn the interactive pet robot on and off by tapping on the interactive pet robot so that an accelerometer and/or other sensor(s) may register the taps and take action. The interactive pet robot can be charged in any suitable manner, such as via a USB connection, an AC/DC adaptor, wireless charging, or other methods.

Interactive Pet Robot Components

This section describes the various components of the interactive pet robot. Dimensions for the interactive pet robot can vary based on, for example, the size of the target animal.

FIG. 1 illustrates an exploded view of an example interactive pet robot 100 according to this disclosure. The embodiment of the interactive pet robot 100 shown in FIG. 1 is for illustration only. Other embodiments of the interactive pet robot 100 could be used without departing from the scope of this disclosure. Those skilled in the art will recognize that, for simplicity and clarity, some features and components are not explicitly shown in every figure, including those illustrated in connection with other figures. Such features, including those illustrated in other figures, will be understood to be equally applicable to the interactive pet robot 100. It will also be understood that all features illustrated in the figures may be employed in any of the embodiments described. Omission of a feature or component from a particular figure is for purposes of simplicity and clarity and not meant to imply that the feature or component cannot be employed in the embodiments described in connection with that figure.

As shown in FIG. 1, the interactive pet robot 100 includes a core 102, a shell 104, a right wheel 106, a left wheel 108, and a tail 110. The core 102 can house various electromechanical components of the interactive pet robot, such as one or more printed circuit board assemblies (PCBAs), motors, gears, sensors, batteries or other power supplies, speakers, and microphones. Axles 112-114 at opposite ends of the core 102 provide attachment points for the wheels 106-108. The core 102 could have any suitable size, such as a length of about 130 mm, an inner diameter of about 21 mm, and an outer diameter of about 25 mm. The core 102 fits inside the shell 104 and is protected by the shell 104 so that the core 102 is not exposed to the animal or external conditions. Further details of the core 102 are provided below.

The shell 104 covers the core 102 and protects the core 102 from abuse, wear, and ingress. The shell 104 may be chewed by an animal, so it can be formed of plastic (such as nylon), rubber, synthetic rubber, or any other material suitable for animal chewing. In some embodiments, the shell 104 may be formed of a rigid plastic (such as polycarbonate) to protect the core 102 from animal puncture. Depending on the embodiment, the shell 104 can be formed with different colors, shapes, and textures. As shown in FIG. 1, the shell 104 includes an opening 116 into which the core 102 can be inserted. Alternatively, the shell 104 can be formed by multiple sections (such as two sections) that are brought together and assembled around the core 102. The shell 104 also includes an attachment point 118 for attaching the tail 110 to the shell 104. In some embodiments, the shell 104 includes a camera 120 for capturing still or video images. Further details of the shell 104 are provided below.

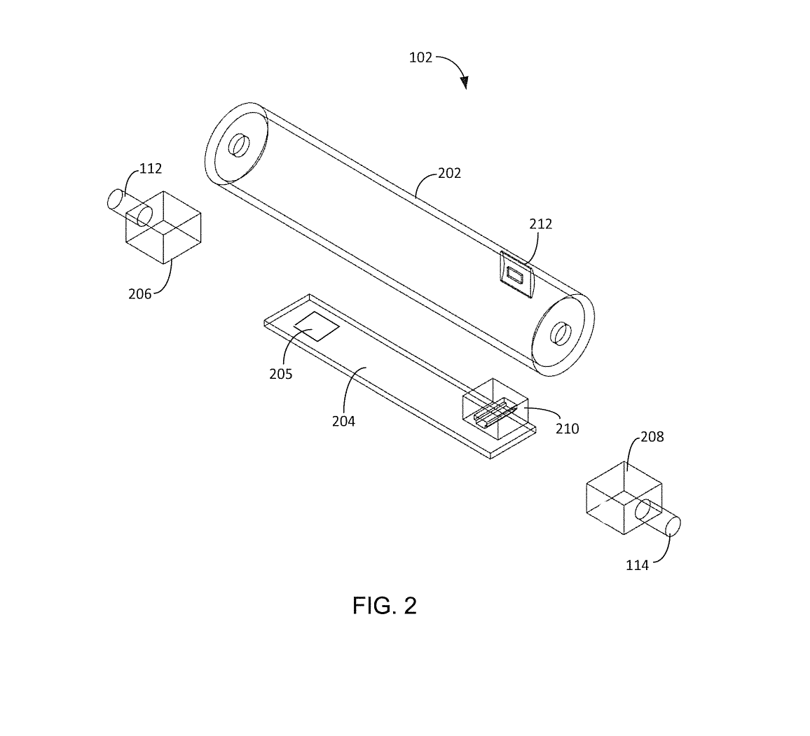

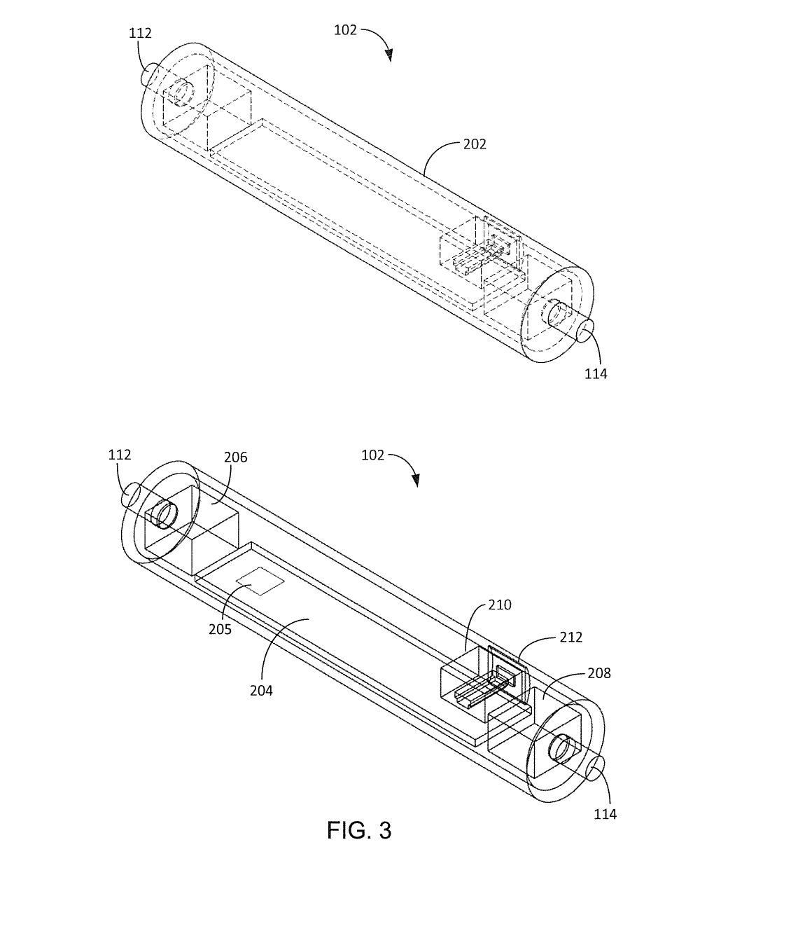

FIGS. 2 and 3 illustrate major components of a core 102 of the interactive pet robot 100 of FIG. 1 according to this disclosure. In particular, FIG. 2 illustrates an exploded perspective view of the components of the core 102, and FIG. 3 illustrates assembled perspective views of the components of the core 102. As shown in FIGS. 2 and 3, the core 102 includes a housing 202, a printed circuit board assembly (PCBA) 204, at least one processing device 205, a right motor 206 with associated gear train, a left motor 208 with associated gear train, a power supply 210, and at least one charging/data port 212.

The housing 202 could be virtually indestructible by and inaccessible to animals. The housing 202 can be made of a strong material such as rigid plastic (like polycarbonate or nylon), carbon fiber, or KEVLAR. The material may be translucent so that light (such as from LEDs inside the interactive pet robot) can shine through the housing 202. The housing 202 can be any geometrical shape, such as cylindrical or rectangular. Small holes on the housing 202 may be provided so that sensors (such as ultrasonic or infrared sensors), speakers, microphones, and cameras can access the environment outside the housing 202.

The processing device 205 includes various electrical circuits for supporting operation and control of the interactive pet robot, including operation and control of the motors 206-208. The processing device 205 may include any suitable number(s) and type(s) of processors or other devices in any suitable arrangement. Example types of processing devices 205 include microprocessors, microcontrollers, digital signal processors, field programmable gate arrays, application specific integrated circuits, and discrete circuitry. In some embodiments, the processing device 205 is disposed on the PCBA 204, although the processing device may be disposed in other locations.

The motors 206-208 provide locomotion for the interactive pet robot 100. The motors 206-208 could provide enough torque to escape the clutches of an animal and to move through or on grass, carpet, and floors. At a minimum, the motors 206-208 provide the interactive pet robot 100 with suitable locomotive power to move around any substantially planar or other surface. The motors 206-208 drive the axles 112-114, which protrude from opposite sides of the core 102 so that the wheels 106-108 can be mounted directly on the axles 112-114. The axles 112-114 can be made of metal, plastic, or other materials. Each gear train can be made of plastic, metal, or other materials and can be inserted between the motor shaft and a final shaft in order to manipulate torque, speed, and other motor output characteristics. Bearings and bushings may be used to protect against excessive motor wear due to excessive forces acting on the motor shafts.

The power supply 210 could include at least one battery or other suitable power sources. Batteries could include rechargeable or single-use batteries. The charging/data port 212 can be used for charging the power supply 210 and exchanging data with the interactive pet robot 100 over a wired connection. In some embodiments, the charging/data port 212 can be a USB-type port or similar. Also, in some embodiments, the charging/data port 212 could be used to facilitate communication between the interactive pet robot 100 and a host (such as a computer). The port 212 could be hidden and not be visible or accessible while animals are interacting with the interactive pet robot. Note, however, that in some implementations the interactive pet robot 100 may also be charged wirelessly. Also note that, in some implementations, charging and data exchange may be handled by two or more ports. In particular embodiments, in order to prevent the interactive pet robot 100 from turning on inadvertently during shipping, the user may be required to plug in a new interactive pet robot into a wired connection in order to turn the pet robot on for the first time.

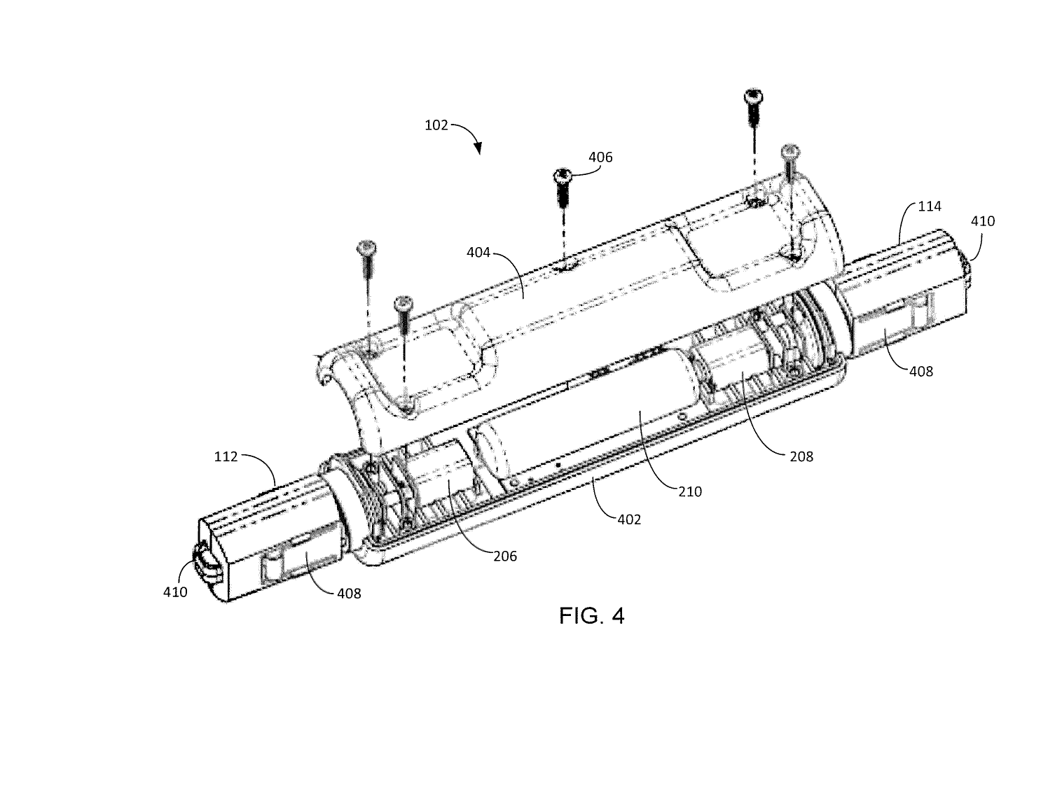

FIG. 4 illustrates a more detailed view of one embodiment of the core 102 according to this disclosure. In this embodiment, the core 102 is formed as two housing parts 402-404 that are brought together and secured with fasteners 406. Also, in FIG. 4, the axles 112-114 of the core 102 include clips 408 to secure the wheels 106-108 and a detachment mechanism 410. Actuation of a detachment mechanism 410 releases the associated wheel 106-108 from the clip 408 for removal from the axle 112-114.

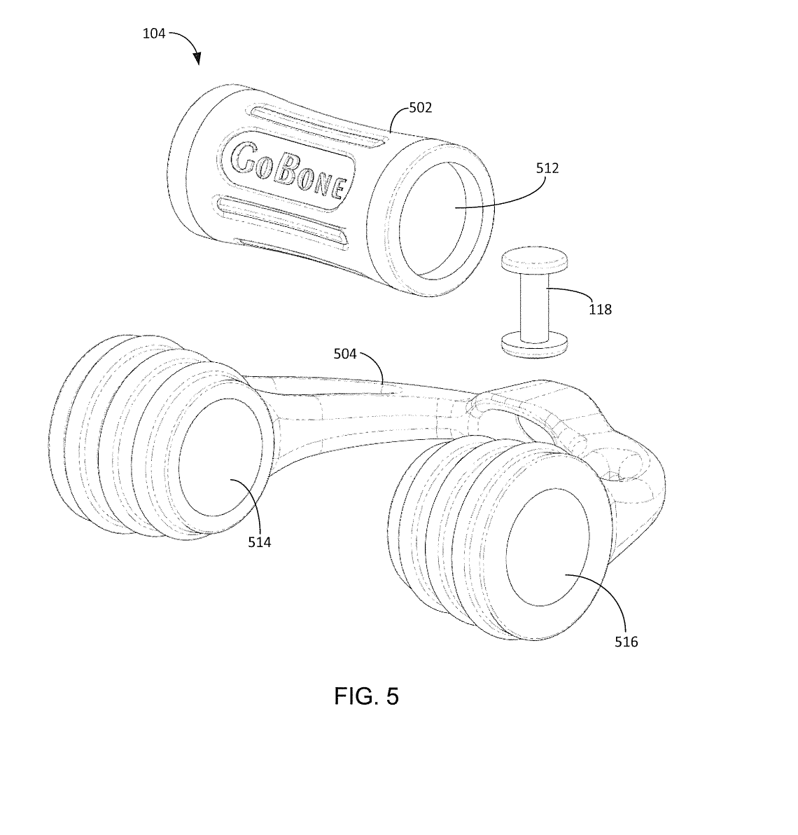

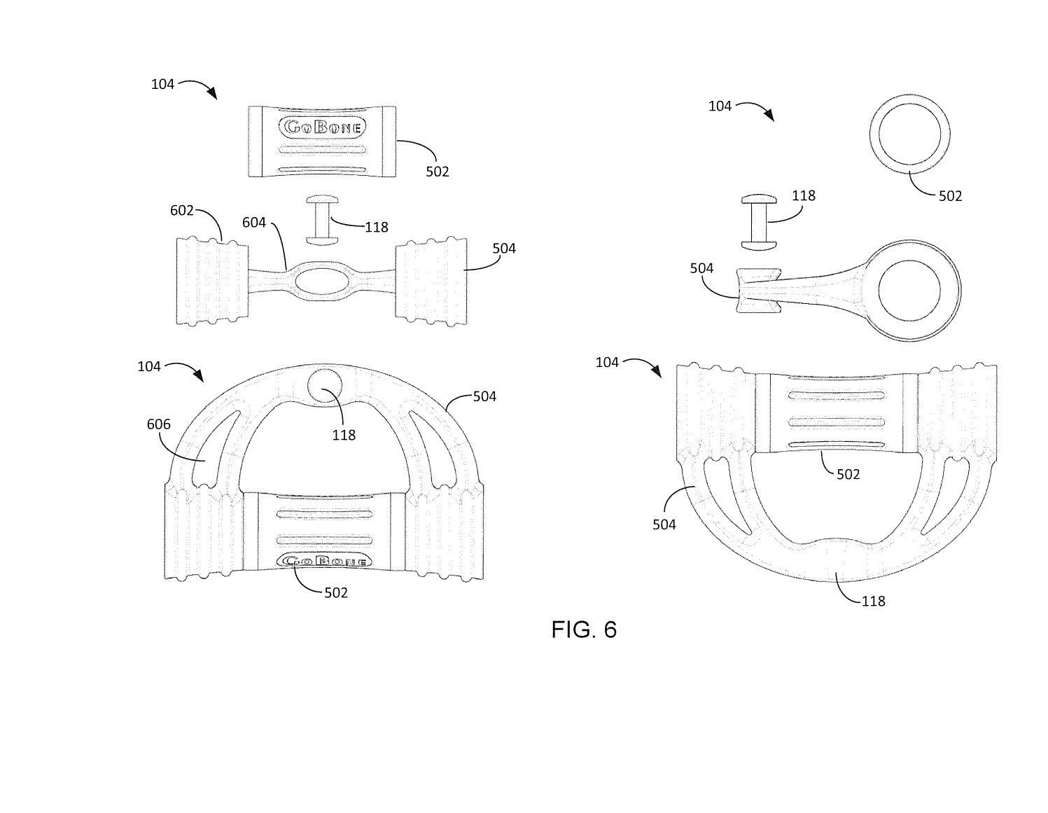

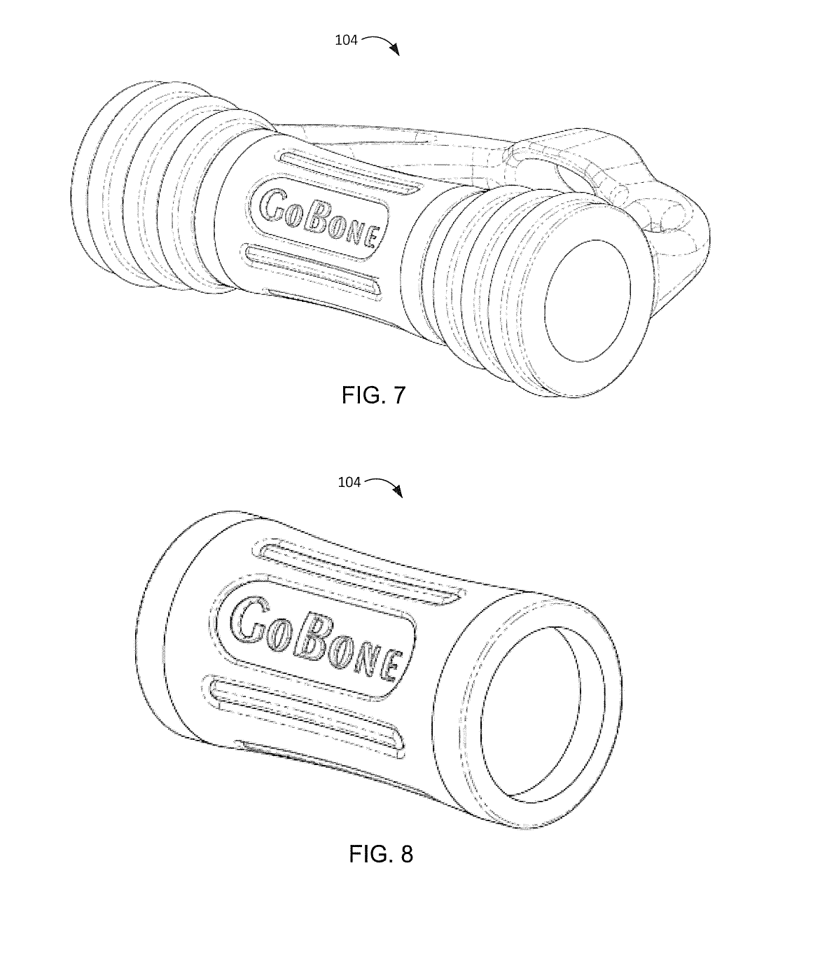

FIGS. 5 through 8 illustrate major components of a shell 104 of the interactive pet robot 100 of FIG. 1 according to this disclosure. In particular, FIG. 5 illustrates a perspective view of the major components of the shell 104, FIG. 6 shows the shell 104 from multiple angles, FIG. 7 shows a perspective view of the assembled shell 104, and FIG. 8 illustrates translucent areas of an embodiment of the shell 104. As shown in FIGS. 5 through 8, the shell 104 includes an inner shell 502, an outer shell 504, and the attachment point 118.

The inner shell 502 and the outer shell 504 are configured to be assembled as shown in FIGS. 6 and 7. The inner shell 502 includes an opening 512 configured to receive a portion of the core 102. Similarly, the outer shell 504 includes openings 514-516 configured to receive additional portions of the core 102. When the inner shell 502 and the outer shell 504 are brought together as shown in FIGS. 6 and 7, the openings 512-516 align to form one continuous opening in which the core 102 is placed. The diameters of the openings 512-516 can result in a tight fit between the shell 104 and the core 102.

The inner shell 502 could be made of plastic (such as nylon), rubber, synthetic rubber, or any other material suitable for animal chewing. The inner shell 502 may feature a logo or other identifying symbol, and the inner shell 502 may have translucent areas in order to let light (such as from LEDs) shine through the inner shell 502. FIG. 8 show translucent areas repeated as a pattern around the inner shell 502.

The outer shell 504 may be made of plastic (such as nylon), rubber, synthetic rubber, or any other material suitable for animal chewing. As seen in FIG. 6, the outer shell 504 could include a wide chewing area 602 for animals with larger jaws, a narrow chewing area 604 for animals with smaller jaws, and voids 606 that reduce the toy's weight and make the chewing area narrower.

The attachment point 118 denotes a location where an accessory, such as the tail 110, can be attached to the interactive pet robot 100. Accessories can be fastened in a way that prevents the animal from removing the accessory or in a way that allows the accessory to break away from the interactive pet robot 100. The fastening mechanism, such as a buckle, clip, button, hook, screw, latch, magnet pair, or other option, can be made of plastic, metal, or other materials. The attachment point 118 may be removable, or it can be manufactured with the rest of the outer shell 504 as one piece. The attachment point 118 could be made out of a low-friction, non-scuffing material such as nylon, carbon fiber, KEVLAR, or any other material meeting the desired durability requirements since it may make contact with the ground as the interactive pet robot 100 moves around.

Because the shell 104 may be chewed by the animal, the shell 104 could be replaceable, and an attachment and detachment mechanism can be used to allow the shell 104 to be mounted and dismounted. In some embodiments, the core 102 is simply inserted into the openings 512-516. In other embodiments, the inner shell 502 and outer shell 504 could each be formed as two separable parts that fit together and attach around the core 102.

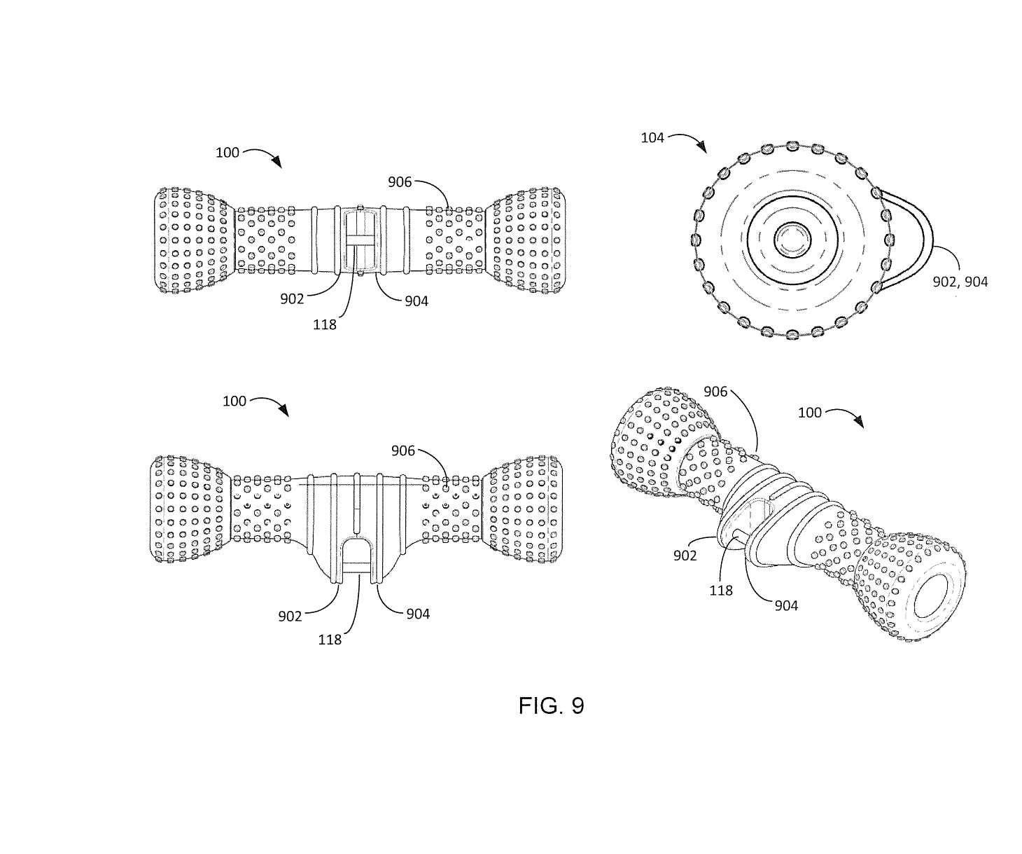

FIG. 9 illustrates different views of an alternative design for the shell 104 according to this disclosure. The shell 104 in FIG. 9 can be suitable for bigger or heavier animals. In FIG. 9, the shell 104 does not include a narrow chewing area for safety reasons. The shell 104 includes a left contact point 902 between the shell 104 and the ground, a right contact point 904 between the shell 104 and the ground, the attachment point 118, and multiple nubs 906 for improving the animal's grip on the shell 104.

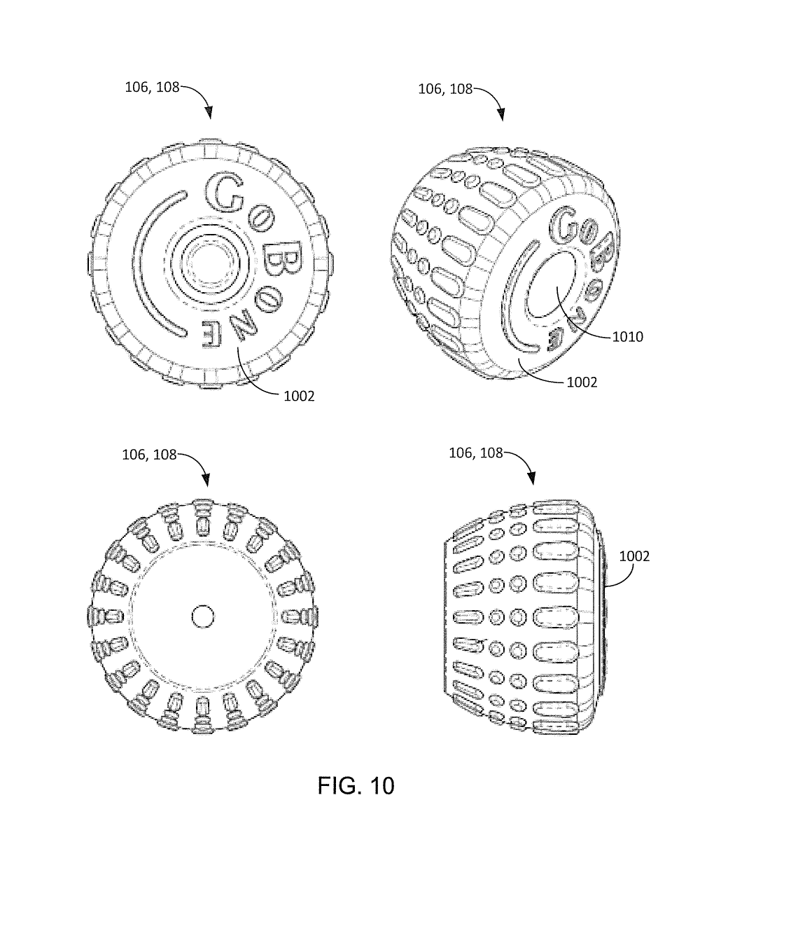

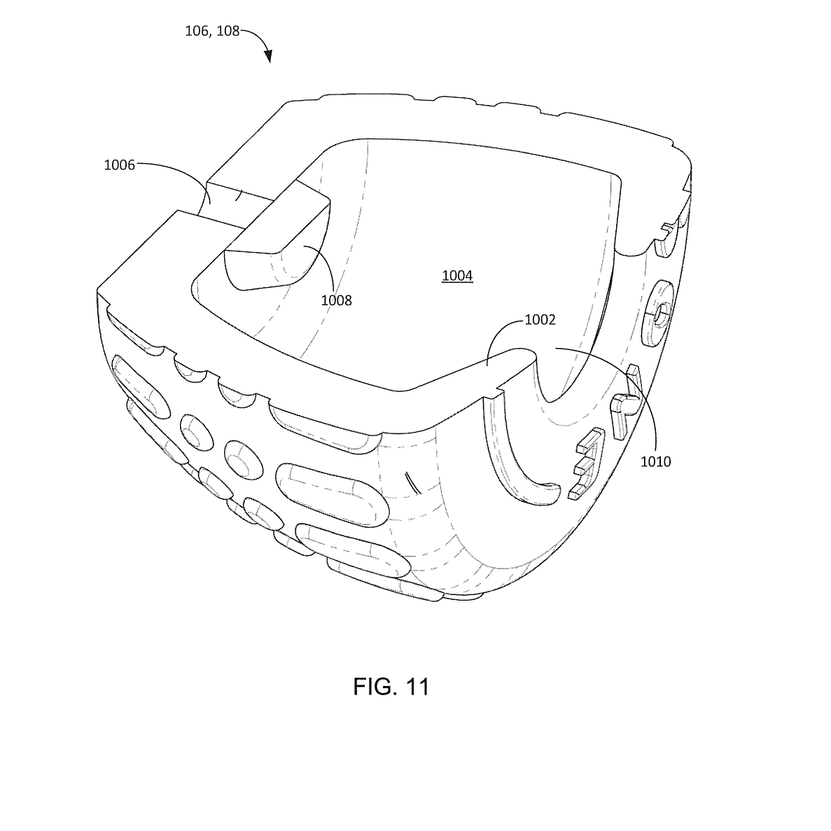

FIGS. 10 and 11 illustrate major components of wheels 106-108 of the interactive pet robot 100 of FIG. 1 according to this disclosure. In particular, FIG. 10 illustrates different views of a wheel 106-108 from different angles, and FIG. 11 illustrates a sectional view of a wheel 106-108. The embodiment of the wheels 106-108 shown in FIGS. 10 and 11 is for illustration only. Other embodiments of the wheels 106-108 could be used without departing from the scope of this disclosure.

The wheels 106-108 can be used to provide locomotion for the interactive pet robot 100. The wheels 106-108 can be made of rubber, synthetic rubber (such as a thermoplastic elastomer), or other materials. The wheels 106-108 may be manufactured with different patterns, textures, and colors, as well as in different shapes, sizes, and material strengths. Each wheel 106-108 connects to a respective axle 112-114, which in turn connects to a respective motor 206-208. The size of the wheels 106-108 can depend on the animal size, and example sizes may include approximately 60 mm, 88 mm, and 115 mm in diameter.

As shown in FIGS. 10 and 11 each wheel 106-108 includes a lip 1002, an internal cavity 1004, an axle attachment point 1006, and an axle attachment/detachment mechanism 1008. The internal cavity 1004 has an opening 1010 so that food and other edibles can be inserted into the internal cavity 1004. Edibles inside the wheel 106-108 may be released through the opening 1010 (e.g., due to centrifugal forces, etc.) while the interactive pet robot 100 (and the wheels 106-108) are in motion or when the animal reaches inside with its tongue. The lip 1002 and an inner multi-way flap (not shown) may control the distribution of edibles. In some embodiments, the wheel 106-108 may have multiple air holes to avoid creating a suction trap (such as for an animal's tongue). Each wheel 106-108 can be replaceable and can be mounted directly on the axle 112-114 at the axle attachment point 1006. The attachment/detachment mechanism 1008 can allow for secure mounting and dismounting of the wheel 106-108. The attachment/detachment mechanism 1008 can include any suitable mechanism for mounting and dismounting, including one or more clips, magnets, frictional elements, keys, screws, resistance or pressure elements, or bolts.

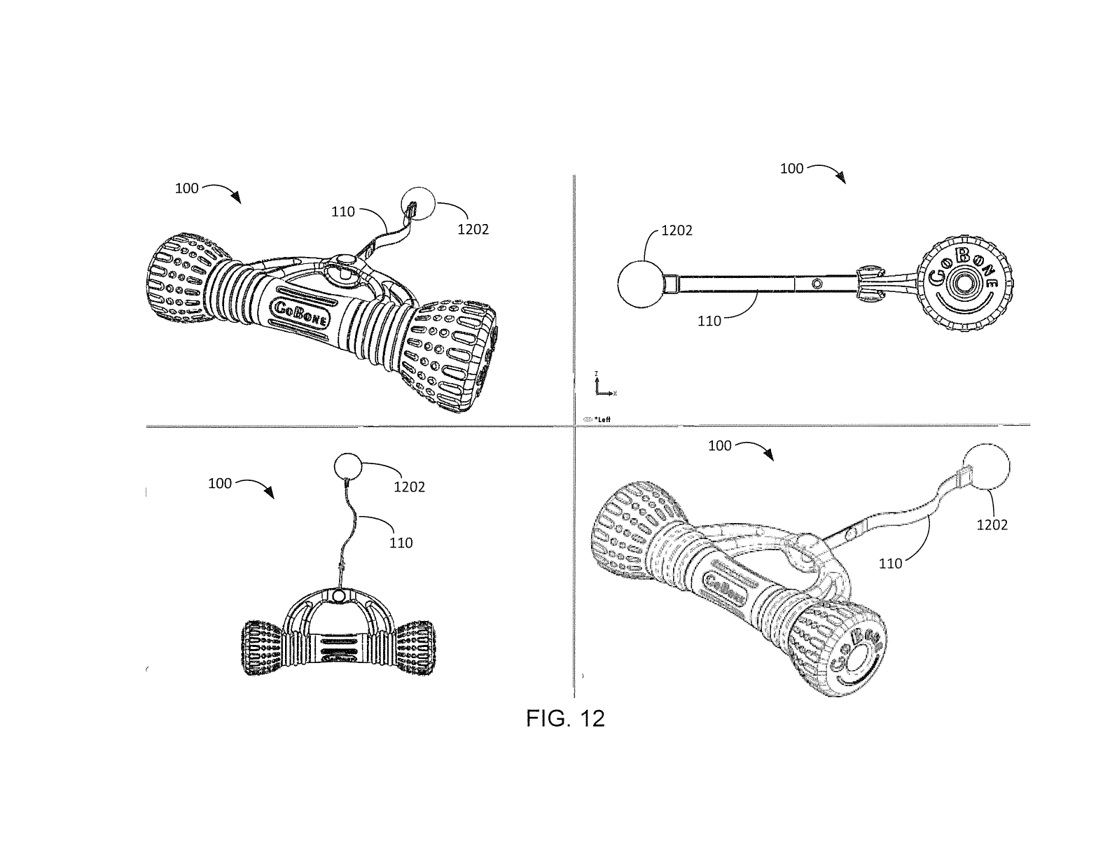

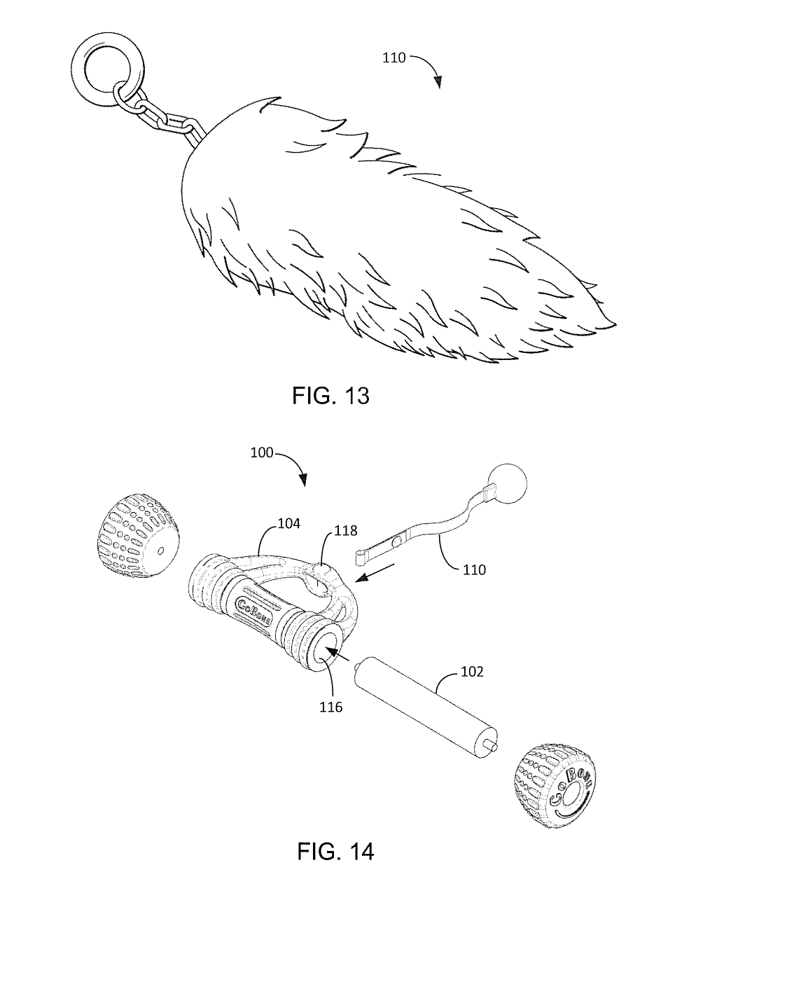

FIG. 12 illustrates different views of the interactive pet robot 100 with the tail 110 attached according to this disclosure. The tail 110 may be attached at the attachment point 118. Once attached, the tail 110 moves with movement of the robot 100 and is designed to further attract the attention of the animal. The tail 110 can be made of plush fabric (such as polyester) or other textile. The tail 110 can also be made from other materials suitable for chewing, such as plastic, rubber, or synthetic rubber. The tail 110 can be waterproof and colorfast and come in different colors, textures, and sizes. One or more squeakers, such as those made of plastic, may be inserted and removed along the length of the tail 110. The discussion of the attachment point 118 above provides example fastening mechanisms for the tail 110. As shown in FIG. 12, the tail 110 includes a connection point or holder 1202 where a squeaker can be inserted or attached to the tail 110. FIG. 13 illustrates one example of a tail 110 with another attachment/detachment mechanism. In FIG. 13, the tail 110 is foimed in the style of a furry animal tail.

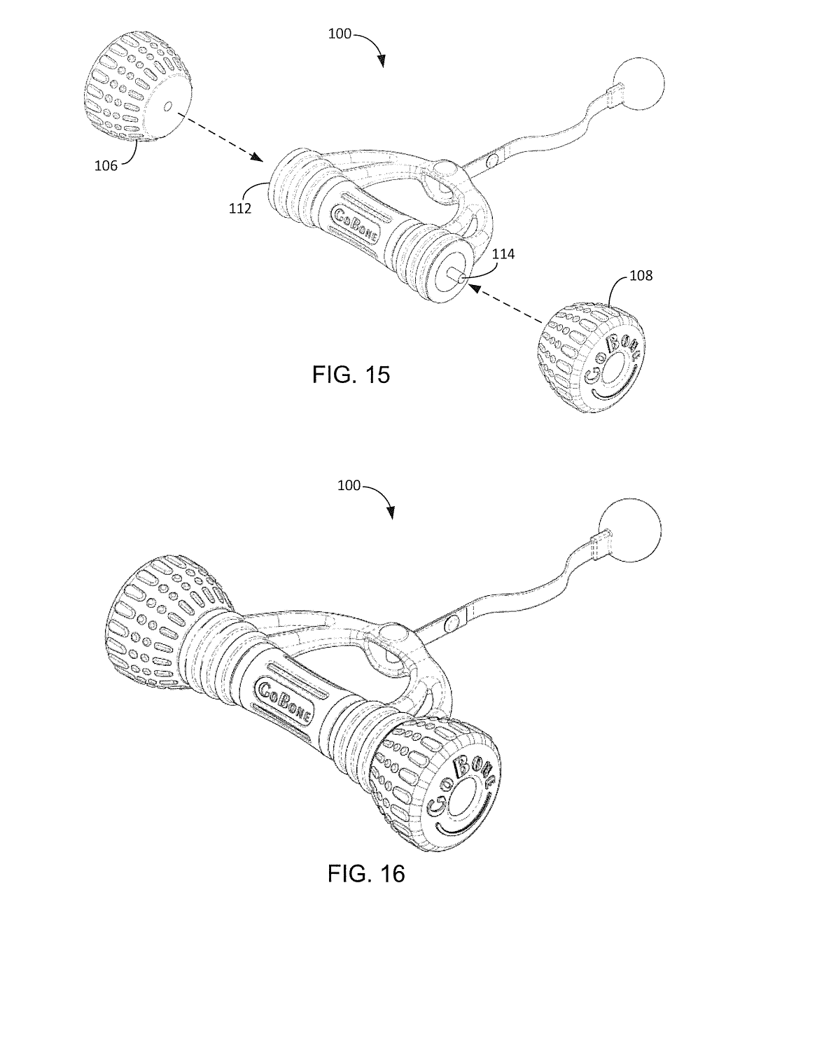

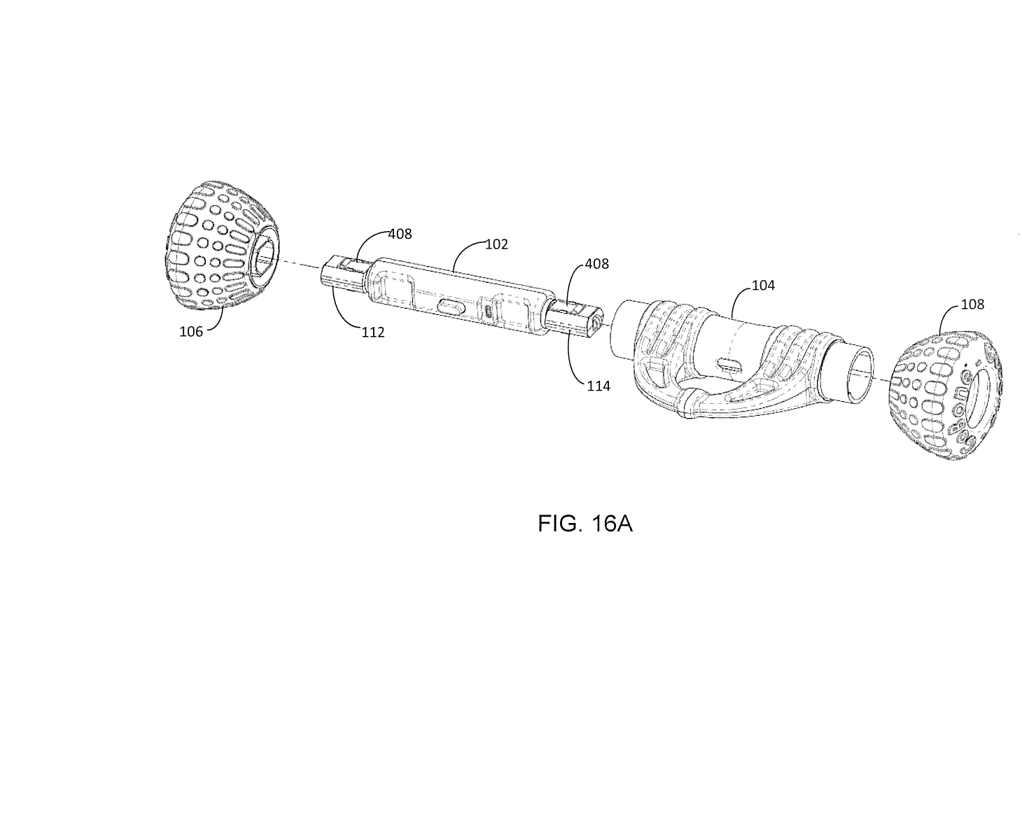

FIGS. 14 through 16 illustrate example steps for assembling the components of the interactive pet robot 100 according to this disclosure. In FIG. 14, the core 102 and the shell 104 are brought together by positioning the core 102 through the opening 116 in the shell 104, as indicated by the arrow. The tail 110 is also attached to the shell 104 at the attachment point 118. In FIG. 15, the wheels 106-108 are attached to the axles 112-114. FIG. 16 shows the assembled interactive pet robot 100 of FIG. 1 according to this disclosure. FIG. 16A illustrates an exploded view of the interactive pet robot 100 with an embodiment of core 102 shown in FIG. 4. The components shown in FIG. 16A can be assembled in a manner similar to that shown in FIGS. 14 through 16. As can be seen here, it is an easy task to assemble the interactive pet robot 100 and to replace individual components of the interactive pet robot 100 as needed or desired.

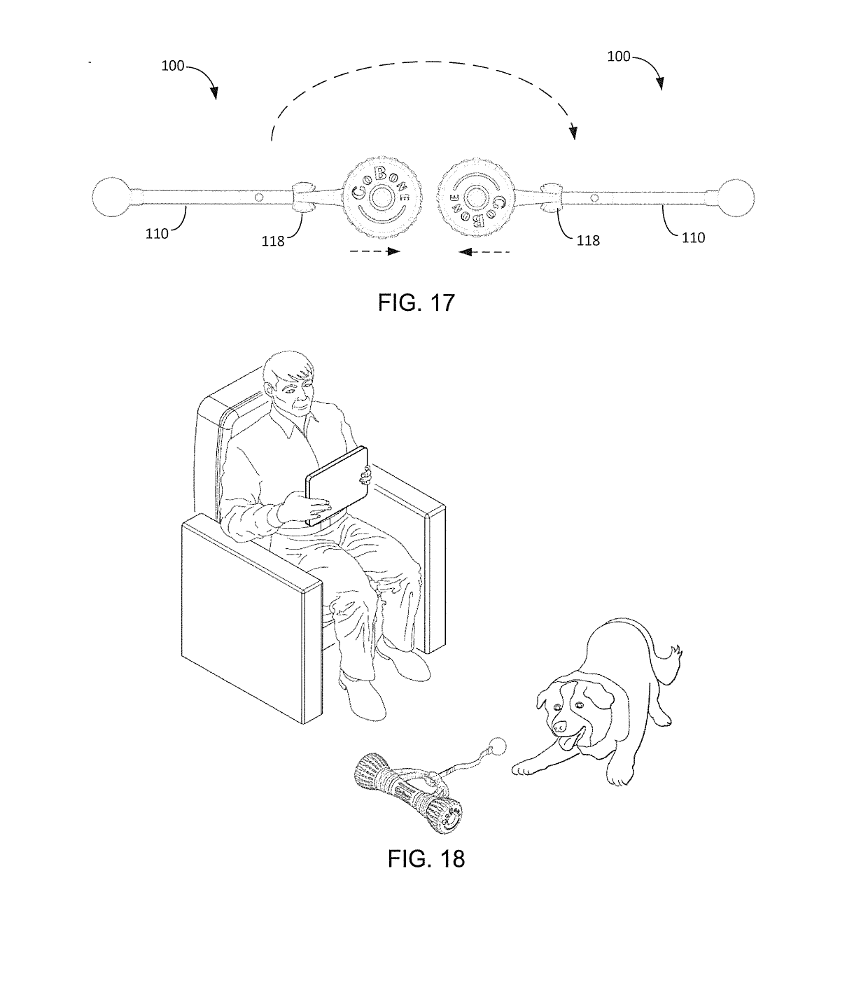

In the illustrated examples, the interactive pet robot 100 moves on two wheels 106-108. The attachment point 118, the tail 110, or both may meet the ground when the interactive pet robot 100 moves linearly in order to prevent the shell 104 from spinning in place when the wheels 106-108 rotate and move the interactive pet robot 100 linearly. Different shells may have different movement mechanics. For the interactive pet robot 100 in FIG. 16, the shell 104 and attachment point 118 are configured such that the attachment point 118 always tends to fall behind the interactive pet robot 100 when the robot 100 moves linearly. In some embodiments, the attachment point 118 arches over the interactive pet robot 100 when there is a change in linear direction so that the attachment point 118 always remains behind the interactive pet robot. For example, FIG. 17 illustrates the interactive pet robot 100 of FIG. 1 changing directions according to this disclosure. In FIG. 17, the interactive pet robot 100 moves to the right with the tail 110 making contact with the ground behind the interactive pet robot 100. If the interactive pet robot 100 changes direction and starts moving to the left, the attachment point 118 and the tail 110 arc over the interactive pet robot 100 so that the tail 110 makes contact with the ground behind the interactive pet robot 100.

Although FIGS. 1 through 17 illustrate particular examples of an interactive pet robot 100 and related components, various changes may be made to FIGS. 1 through 17. For example, the interactive pet robot 100 could include any number of sensors, cameras, locomotive components, transceivers, controllers, processors, and other components. Also, the makeup and arrangement of the interactive pet robot 100 and related components in FIGS. 1 through 17 is for illustration only. Components could be added, omitted, combined, or placed in any other suitable configuration according to particular needs. Further, particular functions have been described as being performed by particular components of the interactive pet robot 100, but this is for illustration only. In general, such functions are highly configurable and can be configured in any suitable manner according to particular needs. In addition, the various designs and form factors for the components of the interactive pet robot 100 can vary in any number of ways.

User Experience

This section describes how a user and an animal interact with the interactive pet robot. FIG. 18 shows an example of a family using a mobile device to control an example instance of the interactive pet robot 100 according to this disclosure. In particular, FIG. 18 shows an example of a family using a mobile device to control the interactive pet robot 100 while their dog plays with the interactive pet robot in their living room.

During an initial or first use, the following process can occur.
A user unboxes the interactive pet robot 100 and assembles the core 102, shell 104, wheels 106-108, tail 110, and any other accessories.
The user downloads an “app” or other application associated with the interactive pet robot 100 from an app marketplace (such as APPLE APP STORE or GOOGLE PLAY) onto a smart device (such as a mobile phone or tablet).
The user turns on the interactive pet robot 100.
The user launches the app on the smart device and connects to the interactive pet robot 100. In some embodiments, the smart device and the interactive pet robot 100 establish a BLUETOOTH or WI-FI connection. Of course, the smart device and the interactive pet robot 100 can establish a connection using any other suitable communication protocol or technology, including a wireless or wired connection.
The user creates an animal profile for his or her animal(s) as described below.
The user completes “Bonding Mode” as described below.
The user now has full access to the functionality of the interactive pet robot 100.

After the initial setup, the interactive pet robot 100 can be used as follows:

1. The user turns on the interactive pet robot 100.

2. The user puts a small amount of food or treats in one or both wheels 106-108 and/or applies a treat paste to portions of the shell 104 (this is an optional step).

3. The user places the interactive pet robot 100 down in front of the animal.

4. The interactive pet robot 100 goes into either Autonomous Operation or Manual Operation mode based on the following. If the user connects to the interactive pet robot 100 via the app within a threshold time (such as 30 seconds), the interactive pet robot 100 goes into Manual Operation mode. If the user does not connect to the interactive pet robot 100 via the app within the threshold time, the interactive pet robot 100 goes into Autonomous Operation mode. Note that the user can take control of the interactive pet robot 100 at any time by pressing “Connect” or another suitable option in the app.

5. During Autonomous Operation, the interactive pet robot 100 autonomously interacts with the animal. Autonomous interaction means that no control of the interactive pet robot 100 by a user is required. For example, during Autonomous Operation, one or more of the following can occur:
The animal eats/licks edibles from the interactive pet robot 100 if available.
The animal chases and chews on the interactive pet robot 100.
The interactive pet robot 100 chases the animal and convinces the animal to chase it. For example, the interactive pet robot 100 may use one or more location sensors or a camera to identify and move toward the animal, then entice the animal to chase the interactive pet robot 100 by moving quickly, making one or more sounds, activating one or more lights, or any other actions that would stimulate the animal's prey drive.
The interactive pet robot 100 performs any other interactive actions with the animal, including Fetch, Hide and Seek, or any of the other games described below.

6. The interactive pet robot 100 goes to sleep after either the animal disengages with the interactive pet robot 100 (such as when the interactive pet robot 100 can sense inactivity via its sensors and go into sleep mode to conserve power) or the interactive pet robot 100 disengages with the animal. In some embodiments, the interactive pet robot 100 disengages with the animal during certain intervals. For example, every x minutes, the interactive pet robot 100 can shut down and behave like a typical inanimate chew toy until the interactive pet robot 100 reawakens. This prolongs battery life, such as by allowing the user to achieve eight hours of fifteen-minute operation per hour versus two hours of continuous operation. Also, after the power supply is depleted, the interactive pet robot 100 can shut down and behave like a typical inanimate chew toy until recharged by the user.

7. The interactive pet robot 100 wakes up after y minutes of inactivity and goes into Autonomous Operation mode. In some embodiments, after waking up, the interactive pet robot 100 may locate the animal if an optional collar clip is available. The collar clip can be worn by the animal and is equipped with a wireless locator, such as a BLUETOOTH chip. The interactive pet robot 100 can move to within a specified distance (such as 1-5 feet) of the animal. Example techniques that could be used here to support this function include using signal strength (such as RSSI) to approximate the distance between a wireless radio (such as a BLUETOOTH chip) on the interactive pet robot 100 and a wireless radio (such as a BLUETOOTH chip) on the collar clip. Collision avoidance can be performed via one or more sensors so the interactive pet robot 100 will avoid most obstacles during its search. Similarly, an accelerometer or other sensor can detect collisions so the interactive pet robot 100 can change direction and avoid getting stuck if it fails to avoid an obstacle during its search.

8. The interactive pet robot 100 also wakes up when the user connects to the interactive pet robot 100 via the app. At this point, the user takes control of the interactive pet robot 100. The user may control the interactive pet robot 100 via a personal area network (PAN) or local area network (LAN) when the user is home or via a wide area network (WAN) when the user is away from home.

9. The interactive pet robot 100 also wakes up when the interactive pet robot's sensor(s) detect that the animal is interacting with it. The interactive pet robot 100 may wake up after one or more interactions during a certain amount of time.

The steps of Autonomous Operation can be repeated until the power supply 210 dies or drops below some threshold level or until the owner intervenes by turning off the interactive pet robot 100 (such as to charge it, disable it, and the like) or switching to Manual Operation.

During Manual Operation, the app is launched, and the user is presented with a “Control” screen. In the “Control” screen, the user controls the interactive pet robot 100 like a remote control car, such as by varying its speed and direction. Once a session is finished, the user turns off the interactive pet robot 100 and, if necessary, can recharge the power supply 210.

“Gamification” encourages frequent user and animal interaction with the interactive pet robot 100. Games, such as the ones below, can be played via the app by a user or as part of the Autonomous Operation profile.

Play Pal—Use the interactive pet robot for x number of minutes per day.

Airplay—The interactive pet robot gets x number of minutes of airtime per day, or the interactive pet robot goes airborne x number of times per day.

Fetch—The user “tosses” the interactive pet robot using his or her smart device, meaning the user moves the smart device and the interactive pet robot moves based on the movement of the smart device. Sensors in the smart device can sense the “throw,” and the interactive pet robot moves away from the user according to “throw” mechanics (such as speed, direction, angle, etc.). The animal may or may not retrieve the interactive pet robot.

Boomerang—A variation of Fetch where the interactive pet robot returns to the user after it has been “tossed”.

Prey Driven—The interactive pet robot teases the animal by moving its tail back and forth. As soon as it feels a tug, the interactive pet robot spins in place and/or runs away to entice the animal to catch the tail again.

Hide & Seek—The user loads the interactive pet robot with food/treats and hides it. Once the animal finds it and makes contact with it, the interactive pet robot wakes up and resumes normal operation.

The interactive pet robot 100 can also support group and breed-specific games, such as the following.

Herding/Working Animals—Two or more interactive pet robots 100 move in separate directions, and it is up to the animal to herd them into place. This game can involve interactive pet robot “swarm” functionality.

Scent Hounds—The user hides the interactive pet robot 100 stuffed with food/treats or coated with food/treat paste. The interactive pet robot 100 remains stationary until the animal finds it. Once one or more sensors of the interactive pet robot 100 detect the animal's presence, the interactive pet robot 100 wakes up and resumes normal operation.

Settings for Autonomous Operation can be configured in the app to control features such as speed or acceleration. Also, breed-specific or animal group-specific games can be enabled via the app or automatically depending on what breed has been selected in the app and whether the interactive pet robot detects another interactive pet robot nearby.

In some implementations, the user can be rewarded with virtual trophies, accessory discounts, and other incentives for using the app. The user can also compete with other interactive pet robot users either directly through built-in social networking functionality or indirectly by leveraging existing social networking platforms such as FACEBOOK, TWITTER, or INSTAGRAM. The animal can be rewarded with edibles if available.

Profiles

This section describes profiles employed by the interactive pet robot during Manual Operation and Autonomous Operation. Profiles for Manual Operation may be used while there is a connection between the interactive pet robot 100 and the app but the interactive pet robot 100 is not in use. Actions depend on how much time has elapsed since a user has sent a command. For example, in some implementations, the following actions can occur.
After a short period of time (e.g., 30 seconds-2 minutes), the interactive pet robot 100 performs random intermediate movements.
After an additional period of time (e.g., 2+ minutes), the interactive pet robot 100 goes into Restless Mood or another mood mode characterized by frequent movements, noises, and/or lights.

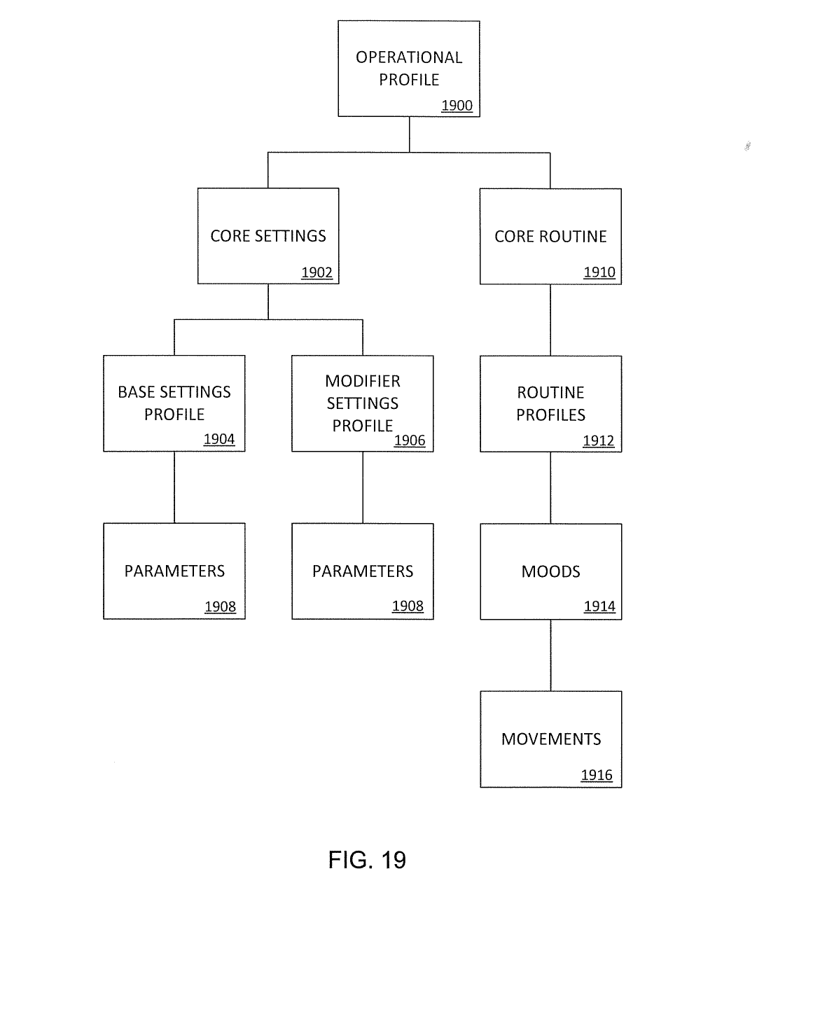

FIG. 19 illustrates an example hierarchical framework for an operational profile 1900 according to this disclosure. The embodiment of the operational profile 1900 shown in FIG. 19 is for illustration only. Other embodiments of the operational profile 1900 can be used without departing from the scope of this disclosure. Operation of the interactive pet robot 100 during Autonomous Operation can be defined by one or more operational profiles 1900. An operational profile 1900 determines the interactive pet robot's autonomous operational characteristics. The interactive pet robot 100 can personalize the user's experience by creating a unique operational profile 1900 for each individual animal. An operational profile 1900 can include various settings 1902-1906, parameters 1908, routines 1910-1912, moods 1914, movements 1916, or combinations of some or all of these.

In Autonomous Operation, the interactive pet robot 100 is capable of various movements 1916. Users can also create their own intermediate and advanced movements 1916, such as by using the interactive pet robot app and/or a software development kit (SDK). For example, movements 1916 can be defined using various parameters. The following are basic or fundamental movements 1916 that could serve as building blocks for intermediate and advanced movements 1916. In the following discussion, movements 1916 can be classified as either linear or rotational.

A movement 1916 is linear when the interactive pet robot 100 gets from point A to point B and the wheels 106-108 move in the same direction during the movement. The wheels 106-108 can move at the same speed or different speeds. Linear movement can be characterized as forward (F) (both wheels move forward), backward (B) (both wheels move backward), or linear rocking (LR) (both wheels alternate between moving forward and backward a given number of times). In LR, the interactive pet robot 100 begins and ends at the same spot. Depending on the embodiment, parameters associated with linear movement can include speed (such as km/hr), duration (such as sec), or distance (such as m). Further parameters associated with LR can include direction, such as direction of rock start (forward or backward), repetitions (such as number of rocking repetitions), and delay (such as delay between front and back motions).

A movement 1916 is rotational when the interactive pet robot 100 spins in place. Rotation can occur when the wheels 106-108 move in different directions and/or at different speeds. Rotation can include fast rotation (FR) (both wheels move in opposite directions), slow rotation (SR) (one wheel moves and the other wheel is stationary), and fast rotation rocking (FRRo). These can be further delineated into fast rotation right (FRR) (left wheel moves forward and right wheel moves backward), fast rotation left (FRL) (right wheel moves forward and left wheel moves backward), slow rotation right (SRR) (left wheel moves forward and right wheel remains stationary), and slow rotation left (SRL) (right wheel moves forward and left wheel remains stationary). In fast rotation rocking, the wheels 106-108 move in opposite directions through a defined angle of rotation, and the interactive pet robot 100 begins and ends in the same spot. One rock is defined as moving from left to right or right to left.

Chaining basic movements together can be done to create intermediate movements, which can be categorized into fixed movements and variable movements. Sensors may not be required to perform these movements. Fixed intermediate movements can have hardcoded parameters that may not be changed in order to maintain the character and spirit of each movement. Example fixed intermediate movements could include: Joy Spin, Happy Skip, Dance, Look Around Random, Look Around Alternating, Launch 1-2-3!, Quick Crawl, Walk in the Park, Serpentine, No No No, Pace, Shake, Twirl, Skate, Linear Rotation, Infinity Sign, Circle, or Square. Each of these fixed intermediate movements is associated with its own characteristics, including various combinations of F, B, LR, FRR, FRL, SRR, SRL, and FRRo.

Variable intermediate movements have variable parameters that can be altered. Example variable intermediate movements can include: forward and turn left; forward and turn right; backward and turn left; and backward and turn right.

Advanced movements denote movements that are the result of real-time interactions between the interactive pet robot 100 and its environment (one or more sensors are employed to perform these movements). Examples of advanced movements can include:
Animal Escape—the interactive pet robot 100 is pinned by the animal and tries to escape.
Collision Detection—the interactive pet robot 100 detects a collision and moves a different direction.
Spin Stop—The interactive pet robot 100 stops spinning when it is in an animal's mouth.
Tap for Treats—The interactive pet robot 100 randomly dispenses food and treats when the animal interacts with it.
   An example session for one of these advanced movements could include the following steps:
The animal makes contact with the interactive pet robot 100.
One or more sensors sense contact and the processing device controls the motors to do a random fast rotation at a random duty cycle (such as between 50-75%). The number of rotations could vary based on the number or sequence of sessions with the animal.

Each operational profile 1900 is defined by core settings 1902 and a core routine 1910. Different operational profiles 1900 can be configured for various animals, including cats and dogs. The core settings 1902 include a base settings profile (BSP) 1904, which includes static operating variables. The BSP 1904 is modified by a modifier settings profile (MSP) 1906, which includes dynamic variables, to create an Autonomous Operational Profile (AOP). The core settings 1902 denote the combination of the BSP 1904 and the MSP 1906. The core settings 1902 define parameters 1908 for different movements in the core routine 1910.

The BSP 1904 defines how each GACS affects movement parameters. Some movements 1916 may be affected and some movements 1916 may not be affected. Example parameters 1908 in a BSP 1904 can include:
Energy Level—the higher the energy level of the animal, the faster the interactive pet robot 100 may move, accelerate, or change direction.
Exercise Needs—the higher the exercise need of the animal, the more often the interactive pet robot 100 should be used.
Prey Drive—the higher the prey drive of the animal, the longer the interactive pet robot 100 should dart forward or backward.
Intelligence—the higher the intelligence of the animal, the more frequent and sharper the turns made by the interactive pet robot 100.
Potential for Mouthiness—the higher the potential for mouthiness of the animal, the longer the interactive pet robot 100 stays still.

In some embodiments, one or more of these parameters could be indicated by a value or range of values, such as when a value of “1” maps to a minimum parameter and a value of “5” maps to a maximum parameter.

The MSP 1906 defines how each IAC affects the BSP 1904. Modifications to the BSP 1904 can be implemented according to a priority level (P#). Example parameters 1908 of the MSP 1906 can include animal name, age, weight, breed, and medical conditions (such as vision problems, hearing problems, weight problems, joint problems, heart problems, and the like). Various operations of the interactive pet robot 100 can change based on these parameters. For example, for an animal with vision problems, the LED indicators could be brighter, have different colors, or blink. For older animals or animals with a weight or joint problem, the interactive pet robot 100 may move or accelerate more slowly. As the animal goes from being overweight to within a healthy weight range, the movement of the interactive pet robot 100 may become quicker and associated with more frequent direction changes.

The core routine 1910 is a routine profile 1912 that is currently in use. The user can create his or her own core routine 1910, such as in an app or an SDK. Routine profiles 1912 can serve as “moods” 1914 to add character and personality to the interactive pet robot 100. In some embodiments, routine profiles 1912 can be defined by the following parameters:
Description—A description of the profile.
Main Characteristics—A sequence of one or more movements 1916.
Triggers—One or more events that trigger the profile.
LED characteristics—brightness, color, blink rate, etc.

Example routine profiles 1912 can include happy, adventurous, relaxed, restless, artistic, nerdy, and random. As a particular example, the happy routine profile 1912 may include the following:
Description—Happy. Expresses joy. Loves life. Life is one big party.
Main Characteristics—Joy Spin, Happy Skip, Dance.
Triggers—Collar clip is within range; continuous interaction with the interactive pet robot 100 as measured by its sensor(s).
LED Characteristics—Green.

An operational profile 1900 can be created by combining specific user inputs along with general animal characteristics, which in turn affects a core routine 1910. For example, an operational profile 1900 can be created as follows.
The user selects the animal type and inputs one or more IACs in the app.
A breed input is matched with a breed in the BCD in order to obtain a specific GACS, such as for the following: energy level, exercise needs, prey drive, intelligence, intensity, potential for mouthiness, and potential for weight gain.
A BSP 1904 is created for the animal using the GACS.
An MSP 1906 is created for the animal using IACs.
The MSP 1906 modifies the BSP 1904 to create the core settings 1902.
A routine profile 1912 is selected as the core routine 1910, such as either randomly or by the user.
The core routine 1910 is modified by the core settings 1902 to create the operational profile 1900.

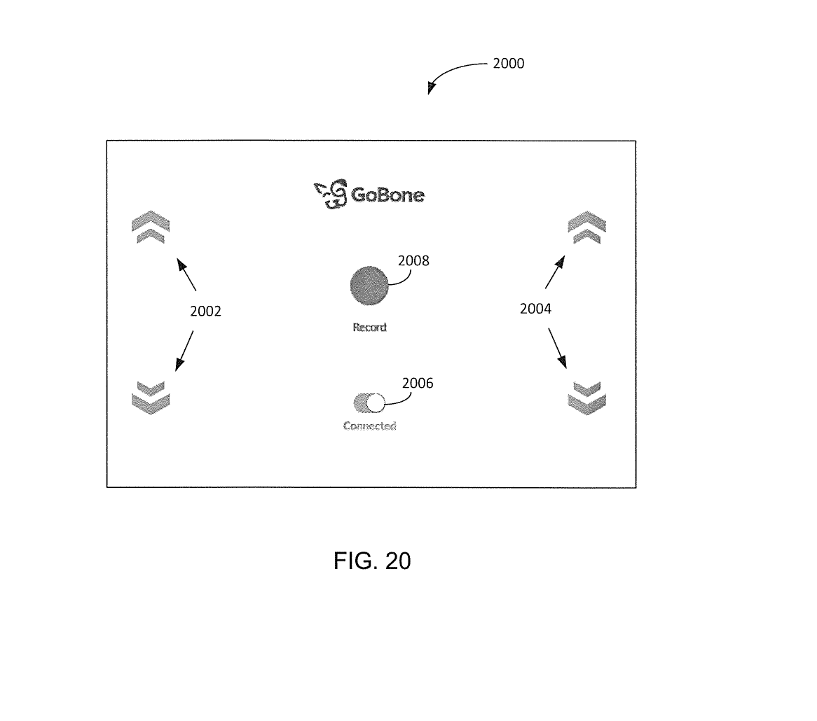

FIG. 20 illustrates an example screen of a mobile app 2000 for use with the interactive pet robot 100 of FIG. 1 according to this disclosure. The embodiment of the mobile app 2000 shown in FIG. 20 is for illustration only. Other embodiments of the mobile app 2000 can be used without departing from the scope of this disclosure. The user can interact with and manage the interactive pet robot 100 through the app 2000 on the user's smart device, such as a mobile phone, smart watch, tablet, laptop, or PC. The functions of the app 2000 can include left wheel movement controls 2002, right wheel movement controls 2004, a connection control 2006, and a record control 2008.

The movement controls 2002-2004 can be actuated to control movement of the interactive pet robot 100. In some implementations, the smart app 2000 could support the following control modes:
Landscape Mode—The user controls the interactive pet robot with two hands in “tank mode”. The user uses his or her thumbs to interact with the movement controls 2002-2004 to control the speed and direction for each wheel 106-108 on the interactive pet robot 100.
Portrait Mode—The user controls the interactive pet robot 100 with one hand. The user selects the speed of the interactive pet robot and uses his or her thumb to interact with a directional pad (not shown) that dictates interactive pet robot behavior (forward, backward, and turns).
Sensor Mode—The user controls the interactive pet robot 100 with one or two hands in “tilt mode”. The user tilts the smart device in the direction of the desired movement of the interactive pet robot 100. The greater the tilt, the faster the interactive pet robot 100 moves.

The user can actuate the connection control 2006 to establish connection to the interactive pet robot, for example, through a PAN, LAN, WAN, or other connection. Using the Record control 2008, the user can capture images and video taken from a camera on the interactive pet robot, a camera on the smart device hosting the app 2000, or both. The captured images and video can be transmitted by the app 2000 by text message, social media channels, or the like.

The mobile app 2000 may include other screens and/or controls for performing other operations. For example, using the mobile app 2000, the user can learn how to use interactive pet robot and perform Bonding Mode, which is described below. The user can also use the mobile app 2000 to update or upgrade interactive pet robot firmware, software, or databases; display statistics on interactive pet robot usage (such as distance travelled, air time, birthday, and gamification elements); receive notifications (such as low battery voltage or poor PAN or WAN connections; and access instructions or a user manual for the interactive pet robot. The user can also use the mobile app 2000 to order products, such as tails or other accessories or an interactive pet robot, or design new interactive pet robot behaviors and routines or modify existing behaviors or routines.

In some implementations, the smart app 2000 could support the following operational modes:
Playpen Mode. This mode optimizes the interactive pet robot's behavior for smaller spaces such as a kitchen or a playpen. In this mode, the interactive pet robot may move in shorter linear distances and/or in place in order to avoid crashing into the perimeter. The interactive pet robot may also experience slower speed and acceleration.
Scheduling Mode. This mode allows the user to schedule the interactive pet robot to operate during certain times of the day. The interactive pet robot may sleep when it is not in use.
Party Mode. This mode allows one smart app 2000 to control multiple interactive pet robots. Each interactive pet robot may be controlled simultaneously or individually.
Creator Mode. The user may manually override Autonomous Operation parameters and create their own interactive pet robot movements. The user may do this by inputting parameters or by drawing a shape on the screen so that the interactive pet robot can follow its outline.

The app 2000 and the interactive pet robot 100 can generate a custom/personalized operational profile for each animal based on individual animal characteristics that the user inputs and information from the BCD. The app 2000 can support multiple profiles that the interactive pet robot 100 will run on, including a default profile and one or more user-selectable profiles. In some embodiments, up to three animal profiles can be created, although other embodiments could support more or fewer animal profiles. One goal of an animal profile is to create a personalized autonomous operational profile for the user's animal(s).

To create an animal profile, the app 2000 asks the user to input the animal's name, age, weight, breed, medical issues, and other or additional unique pet characteristics. One or more algorithms combine individual animal characteristics input by the user with general animal characteristics from the BCD, and a custom/personalized operational profile (such as the operational profile 1900) is generated for the user's animal(s). The app 2000 then asks user to confirm various characteristics, such as: energy level, exercise needs, prey drive, intelligence, intensity, potential for mouthiness, and potential for weight gain. The user has the option to override or change these characteristics. The animal profile is now complete. The user has the option to add new profiles or modify existing profile at a later time.

Bonding Mode can be performed by the user using the mobile app 2000 and the interactive pet robot 100 before Autonomous Operation. Example goals of Bonding Mode are to introduce the interactive pet robot 100 to an animal in a positive way, create a strong bond between the animal and the interactive pet robot 100, and introduce the user to the mechanics and operation of the interactive pet robot 100.

In one implementation, Bonding Mode is performed using the following process. This process may be performed with the mobile app 2000.
The user places edibles, such as food or treats, in the interactive pet robot's wheels 106-108 or accessories and/or applies food paste to the interactive pet robot 100.
The user places the interactive pet robot 100 on the ground and allows the animal to sniff, lick, and eat the edibles for a few minutes.
The interactive pet robot 100 slowly starts to move and determines the animal's reaction to the movement. If the animal stops interacting with the interactive pet robot 100 after motion is introduced (such as because the animal becomes scared or runs away), the interactive pet robot 100 stops moving. The user has the option of refilling the interactive pet robot 100 with edibles and/or attempting to introduce motion again some time later in order to get the animal to interact with the interactive pet robot 100 while the robot 100 is moving.
Speed is carefully increased while ensuring the animal is not scared.
When the animal starts to interact with the interactive pet robot 100 while the robot 100 is moving at full speed, bonding mode is complete. The animal now trusts the interactive pet robot 100 and associates the robot 100 with positive/rewarding experiences. The user may also unlock additional functionality by completing Bonding Mode.

Computing Components

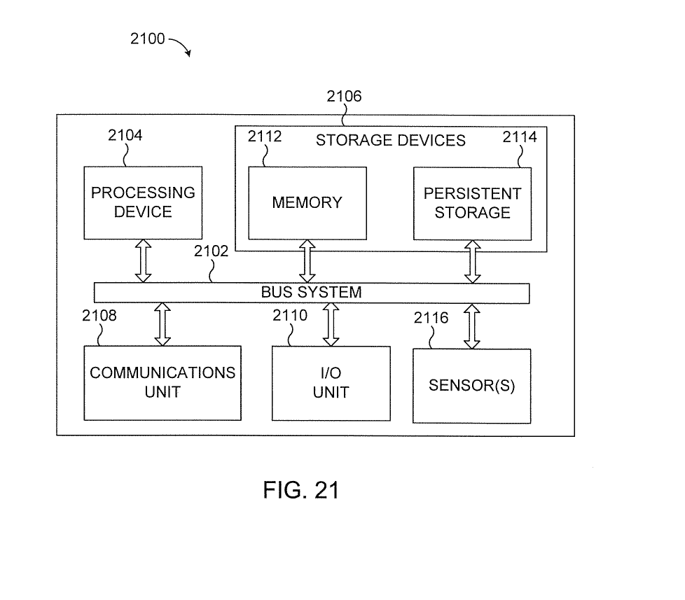

FIG. 21 illustrates an example device 2100 for performing functions associated with operation of an interactive pet robot 100 according to this disclosure. The device 2100 could, for example, represent components disposed in or on the interactive pet robot 100 of FIG. 1, such as components implemented within the core 102 of the robot 100. As another example, the device 2100 could represent the smart device executing the app 2000 of FIG. 20. The device 2100 could represent any other suitable device for performing functions associated with operation of an interactive pet robot 100.

As shown in FIG. 21, the device 2100 can include a bus system 2102, which supports communication between at least one processing device 2104, at least one storage device 2106, at least one communications unit 2108, at least one input/output (I/O) unit 2110, and at least one sensor 2116. The processing device 2104 executes instructions that may be loaded into a memory 2112. The processing device 2104 may include any suitable number(s) and type(s) of processors or other devices in any suitable arrangement. Example types of processing devices 2104 include microprocessors, microcontrollers, digital signal processors, field programmable gate arrays, application specific integrated circuits, and discrete circuitry.

The memory 2112 and a persistent storage 2114 are examples of storage devices 2106, which represent any structure(s) capable of storing and facilitating retrieval of information (such as data, program code, and/or other suitable information on a temporary or permanent basis). The memory 2112 may represent a random access memory or any other suitable volatile or non-volatile storage device(s). The persistent storage 2114 may contain one or more components or devices supporting longer-term storage of data, such as a read only memory, hard drive, Flash memory, or optical disc. The memory 2112 and the persistent storage 2114 may be configured to store instructions associated with control and operation of an interactive pet robot 100.

The communications unit 2108 supports communications with other systems, devices, or networks. For example, the communications unit 2108 could include a wireless transceiver facilitating communications over at least one wireless network. The communications unit 2108 may support communications through any suitable physical or wireless communication link(s).

The I/O unit 2110 allows for input and output of data. For example, the I/O unit 2110 may provide a connection for user input through a touchscreen, microphone, or other suitable input device. The I/O unit 2110 may also send output to a display, speaker, or other suitable output device.

The sensor(s) 2116 allow the device 2100 to measure a wide variety of environmental and geographical characteristics associated with the device 2100 and its surroundings. The sensor(s) 2116 may include at least one temperature sensor, moisture sensor, accelerometer, gyroscopic sensor, pressure sensor, GPS reader, location sensor, infrared sensor, or any other suitable sensor or combination of sensors.

Although FIG. 21 illustrates one example of a device 2100 for performing functions associated with operation of an interactive pet robot, various changes may be made to FIG. 21. For example, various components in FIG. 21 could be combined, further subdivided, or omitted and additional components could be added according to particular needs. Also, computing devices can come in a wide variety of configurations, and FIG. 21 does not limit this disclosure to any particular configuration of device. As particular examples, a user could use a desktop computer, laptop computer, or other computing device to interact with the interactive pet robot 100.

Through the use of the interactive pet robot 100, various goals can be achieved. For example, an animal can be entertained by the interactive pet robot 100 even when the animal's owner is away from home or unable to interact with the animal. Also, the animal's owner can use a camera, microphone, or other components of the interactive pet robot 100 to check up on the animal when the owner is unable to physically view the animal. In addition, the interactive pet robot 100 can be used to effectively put an animal on an exercise routine via its various algorithms, allowing a pet to be exercised from the comfort of the user's own living space. This can be especially useful in inclement or hot weather.

While the interactive pet robot 100 has been described as interacting with a pet, embodiments of the interactive pet robot 100 may also be suitable for interaction with a human, such as a small child or toddler. For example, a toddler may also respond positively to the various movements, sounds, and interactive capabilities of the interactive pet robot 100 described herein.

The following describes example features and implementations of an interactive pet robot 100 and related components and methods according to this disclosure. However, other features and implementations of an interactive pet robot 100 and related components and methods could be used.

In a first embodiment, a pet toy is configured for interaction with an animal. The pet toy includes a core, a shell, and at least one camera. The core includes at least one processing device configured to control one or more operations of the pet toy. The core also includes at least one transceiver configured to transmit to and receive information from a wireless mobile communication device, the received information comprising control information associated with movement of the pet toy. The core further includes at least one motor configured to move the pet toy on a substantially planar surface based on the control information received from the wireless mobile communication device. The shell is configured to at least partially surround and protect the core, and the shell is formed of a rigid plastic material. The shell is configured to be removable from the pet toy without damage to the core. The at least one camera is configured to capture still or video images of the animal while the animal interacts with the pet toy.

Any single one or any combination of the following features could be used with the first embodiment. The at least one transceiver can be configured to receive a movement instruction from the wireless mobile communication device, where the movement instruction includes at least one direction. In response to the received movement instruction, the at least one processing device can be configured to control the at least one motor to move the pet toy in the at least one direction. The at least one transceiver can be configured to connect to and receive information from a local wireless network, and the received information can include real-time control information associated with the movement of the pet toy that is received from a remote location via the local wireless network. The at least one transceiver can be configured to transmit the still or video images to the wireless mobile communication device for output to a display of the wireless mobile communication device. The pet toy may further include at least one microphone configured to receive sound from areas around the pet toy while the animal interacts with the pet toy, and the at least one transceiver can be configured to transmit sound data associated with the received sound to the wireless mobile communication device for output to a speaker of the wireless mobile communication device. The pet toy may also include at least one speaker configured to emit voice sounds transmitted from the wireless mobile communication device. The rigid plastic material could be polycarbonate or nylon. The pet toy may further include at least one rechargeable battery configured to power the pet toy. The wireless mobile communication device could be an iOS or Android device. The pet toy may also include at least one sensor configured to detect at least one characteristic associated with the pet toy or a surrounding environment. The pet toy may also include an attachment point configured to be coupled to an accessory that moves when the pet toy moves. The shell may be comprised of two or more parts that assemble together around the core.

In a second embodiment, a method includes receiving, by at least one wireless transceiver, information from a wireless mobile communication device. The received information includes control information associated with movement of a pet toy configured for interaction with an animal. The pet toy includes a core, a shell, and at least one camera. The method also includes controlling, by at least one processing device, at least one motor to move the pet toy on a substantially planar surface based on the control information received from the wireless mobile communication device. The method further includes capturing, by the at least one camera, still or video images of the animal while the animal interacts with the pet toy. The core includes the at least one processing device, the at least one transceiver, and the at least one motor. The shell at least partially surrounds and protects the core, where the shell is formed of a rigid plastic material. The shell is configured to be removable from the pet toy without damage to the core.

Any single one or any combination of the following features could be used with the second embodiment. The method may also include receiving, by the at least one transceiver, a movement instruction from the wireless mobile communication device, the movement instruction comprising at least one direction. The method may further include, in response to the received movement instruction, controlling, by the at least one processing device, the at least one motor to move the pet toy in the at least one direction. The method may also include connecting to a local wireless network using the at least one transceiver, where the received information includes real-time control information associated with the movement of the pet toy that is received from a remote location via the local wireless network. The method may further include transmitting, by the at least one transceiver, the still or video images to the wireless mobile communication device for output to a display of the wireless mobile communication device. The method may also include receiving, by at least one microphone disposed on or in the pet toy, sound from areas around the pet toy while the animal interacts with the pet toy and transmitting, by the at least one transceiver, sound data associated with the received sound to the wireless mobile communication device for output to a speaker of the wireless mobile communication device. The method may further include emitting, by at least one speaker disposed on or in the pet toy, voice sounds transmitted from the wireless mobile communication device. The rigid plastic material may include polycarbonate. The method may also include powering the pet toy by at least one rechargeable battery. The wireless mobile communication device could be an iOS or Android device.

In a third embodiment, a non-transitory computer readable medium contains instructions that, when executed by at least one processing device, cause the at least one processing device to receive information from a wireless mobile communication device, the received information comprising control information associated with movement of a pet toy configured for interaction with an animal, the pet toy comprising a core, a shell, and at least one camera. The instructions also cause the at least one processing device to control at least one motor to move the pet toy on a substantially planar surface based on the control information received from the wireless mobile communication device. The instructions further cause the at least one processing device to control the at least one camera to capture still or video images of the animal while the animal interacts with the pet toy. The core includes the at least one processing device, at least one transceiver, and the at least one motor. The shell at least partially surrounds and protects the core, the shell formed of a rigid plastic material, the shell configured to be removable from the pet toy without damage to the core.

In a fourth embodiment, an apparatus configured for interaction with an animal includes a core and an outer shell. The core includes at least one processing device configured to control one or more operations of the apparatus and at least one sensor configured to detect a position or orientation of the apparatus. The core also includes at least one transceiver configured to receive control information associated with movement of the apparatus and at least one motor configured to move the apparatus on a surface based on the received control information. The outer shell is configured to at least partially surround and protect the core.

Any single one or any combination of the following features could be used with the fourth embodiment. The at least one transceiver can be configured to receive a movement instruction comprising at least one direction. In response to the received movement instruction, the at least one processing device can be configured to control the at least one motor to move the apparatus in the at least one direction. The at least one transceiver can be configured to connect to and receive information from a local wireless network, and the received information can include real-time control information associated with the movement of the apparatus that is received from a remote location via the local wireless network. The apparatus may also include at least one camera configured to capture still or video images of the animal while the animal interacts with the apparatus, and the at least one transceiver can be configured to transmit the still or video images for output to a display. The apparatus may further include at least one microphone configured to receive sound from areas around the apparatus while the animal interacts with the apparatus, and the at least one transceiver can be configured to transmit sound data associated with the received sound for output to a speaker. The apparatus may also include at least one speaker configured to emit voice sounds, at least one rechargeable battery configured to power the apparatus, and/or an attachment point configured to be coupled to an accessory that moves when the apparatus moves. The outer shell can be formed of a durable material resistant to animal puncture, and the outer shell can be configured to be removable from the apparatus without damage to the outer shell or the core. The at least one transceiver can be configured to receive the control information from a wireless mobile communication device. The wireless mobile communication device can be an iOS or Android device. The at least one sensor can include at least one of: an accelerometer, a gyroscope, a compass, and an inertial measurement unit.

In a fifth embodiment, a method includes receiving, by at least one wireless transceiver, control information associated with movement of an apparatus configured for interaction with an animal, where the apparatus includes a core and an outer shell. The method also includes detecting, by at least one sensor, a position or orientation of the apparatus. The method further includes controlling, by at least one processing device, at least one motor to move the apparatus on a surface based on the received control information. The core includes the at least one processing device, the at least one sensor, the at least one transceiver, and the at least one motor. The outer shell at least partially surrounds and protects the core.

Any single one or any combination of the following features could be used with the fifth embodiment. The method may also include receiving, by the at least one transceiver, a movement instruction comprising at least one direction. The method may further include, in response to the received movement instruction, controlling, by the at least one processing device, the at least one motor to move the apparatus in the at least one direction. The method may also include connecting to a local wireless network using the at least one transceiver, and the received information may include real-time control information associated with the movement of the apparatus that is received from a remote location via the local wireless network. The method may further include capturing, by at least one camera disposed on or in the apparatus, still or video images of the animal while the animal interacts with the apparatus and transmitting, by the at least one transceiver, the still or video images for output to a display. The method may also include receiving, by at least one microphone disposed on or in the apparatus, sound from areas around the apparatus while the animal interacts with the apparatus and transmitting, by the at least one transceiver, sound data associated with the received sound for output to a speaker. The method may further include emitting, by at least one speaker disposed on or in the apparatus, voice sounds and/or powering the apparatus by at least one rechargeable battery. The outer shell can be formed of a durable material resistant to animal puncture, and the outer shell can be configured to be removable from the apparatus without damage to the outer shell or the core. The control information can be received from a wireless mobile communication device. The wireless mobile communication device can be an iOS or Android device. The at least one sensor can include at least one of: an accelerometer, a gyroscope, a compass, and an inertial measurement unit.

In a sixth embodiment, a non-transitory computer readable medium contains instructions that, when executed by at least one processing device, cause the at least one processing device to receive control information associated with movement of an apparatus configured for interaction with an animal, the apparatus comprising a core and an outer shell. The instructions also cause the at least one processing device to control at least one sensor to detect a position or orientation of the apparatus. The instructions further cause the at least one processing device to control at least one motor to rotate to move the pet toy on a surface based on the received control information. The core includes the at least one processing device, the at least one sensor, a transceiver, and the at least one motor. The outer shell at least partially surrounds and protects the core.

In a seventh embodiment, an apparatus configured for interaction with an animal or human includes a core, a shell, at least one sensor, and at least one motor. The core includes at least one processor configured to control one or more operations of the apparatus. The shell is configured to at least partially surround and protect the core. The at least one sensor is configured to detect at least one characteristic or operation associated with the animal or human. The at least one motor configured to operate to move the apparatus on a surface. In response to the at least one detected characteristic of the animal or human, the at least one processor is configured to determine a movement and control the at least one motor to operate to move the apparatus according to the determined movement.

Any single one or any combination of the following features could be used with the seventh embodiment. The at least one characteristic or operation associated with the animal or human can includes at least one of: a location of the animal or human, a movement of the animal or human toward or away from the apparatus, the animal or human touching the apparatus, or the animal or human chewing on the apparatus. The determined movement can include at least one of the following: movement toward the animal or human, movement away from the animal or human, a rocking movement, or a spinning movement. In a bonding mode, the at least one processor is configured to control the apparatus to initially move slowly, determine a reaction of the animal or human to the initial movement, then control the apparatus to stop or move more quickly based on the determined reaction of the animal or human. The apparatus can also include a plurality of wheels operatively coupled to the at least one motor, wherein operation of the at least one motor causes at least one of the wheels to rotate to move the apparatus. The at least one motor can include a first and second motor, the plurality of wheels can include a first and second wheel, and operation of the first motor can cause the first wheel to rotate and operation of the second motor causes the second wheel to rotate. The apparatus can also include first and second axles, each axle comprising a clip, wherein each of the first and second wheels is configured to removably attach to one of the clips on a corresponding axle. Each wheel can include an internal cavity configured to contain edibles, and movement of the wheel causes disbursement of the edibles out of the internal cavity through an opening in the wheel.

The apparatus can further include a transceiver configured to receive control information associated with the apparatus, the control information comprising a movement instruction comprising at least one direction. In response to the received movement instruction, the at least one processor is configured to control the at least one motor to move the apparatus in the at least one direction. The transceiver is configured to connect to and receive information from a local wireless network, the received information comprising real-time control information associated with movement of the apparatus, the real-time control information transmitted to the local wireless network from a remote location. The apparatus can further include a camera configured to capture still or video images of the animal or human while the animal or human interacts with the apparatus, where the transceiver is configured to transmit the still or video images for output to a display. The apparatus can further include at least one microphone configured to receive sound from areas around the apparatus while the animal or human interacts with the apparatus, where the transceiver is configured to transmit sound data associated with the received sound for output to a speaker. The control information can be received from a wireless mobile communication device. The apparatus can also include at least one speaker configured to emit sounds, a rechargeable battery configured to power the apparatus, and an attachment point configured to be coupled to an accessory that moves when the apparatus moves. The shell can be configured to be removable from the apparatus without damage to the shell or the core. The at least one sensor can include at least one of an accelerometer, a gyroscope, a compass, or an inertial measurement unit. The determination of the movement by the at least one processor can be based on an age, weight, breed, or medical condition of the animal. The transceiver can transmit statistics associated with usage of the apparatus by the animal or human.

Note that in the description above, various numerical values are provided, such as for weights, distances, dimensions, speeds, and percentages. These values are examples only, and other implementations could depart from these numerical values. Also, the interactive pet robot 100 described above need not be used with one, some, or any of the algorithms described above. In general, the interactive pet robot 100 could be used in any suitable manner to interact with one or more animals.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A pet toy configured for interaction with an animal, the pet toy comprising:
a core comprising:
at least one processing device configured to control one or more operations of the pet toy;
at least one transceiver configured to transmit to and receive information from a wireless mobile communication device, the received information comprising control information associated with movement of the pet toy; and
at least one motor configured to move the pet toy on a substantially planar surface based on the control information received from the wireless mobile communication device;
a shell configured to at least partially surround and protect the core, the shell formed of a rigid plastic material, the shell configured to be removable from the pet toy without damage to the core; and
at least one camera configured to capture still or video images of the animal while the animal interacts with the pet toy.

2. The pet toy of claim 1, wherein:
the at least one transceiver is configured to receive a movement instruction from the wireless mobile communication device, the movement instruction comprising at least one direction; and
in response to the received movement instruction, the at least one processing device is configured to control the at least one motor to move the pet toy in the at least one direction.

3. The pet toy of claim 2, wherein:
the at least one transceiver is configured to connect to and receive information from a local wireless network; and
the received information comprises real-time control information associated with the movement of the pet toy that is received from a remote location via the local wireless network.

4. The pet toy of claim 3, wherein the at least one transceiver is configured to transmit the still or video images to the wireless mobile communication device for output to a display of the wireless mobile communication device.

5. The pet toy of claim 3, further comprising at least one microphone configured to receive sound from areas around the pet toy while the animal interacts with the pet toy;
wherein the at least one transceiver is configured to transmit sound data associated with the received sound to the wireless mobile communication device for output to a speaker of the wireless mobile communication device.

6. The pet toy of claim 3, further comprising at least one speaker configured to emit voice sounds transmitted from the wireless mobile communication device.

7. The pet toy of claim 3, wherein the rigid plastic material comprises polycarbonate.

8. The pet toy of claim 3, further comprising at least one rechargeable battery configured to power the pet toy.

9. The pet toy of claim 3, wherein the wireless mobile communication device is an iOS or Android device.

10. The pet toy of claim 3, further comprising at least one sensor configured to detect at least one characteristic associated with the pet toy or a surrounding environment.

11. The pet toy of claim 3, further comprising an attachment point configured to be coupled to an accessory that moves when the pet toy moves.

12. The pet toy of claim 3, wherein the shell is comprised of two or more parts that assemble together around the core.

13. A method comprising:
receiving, by at least one wireless transceiver, information from a wireless mobile communication device, the received information comprising control information associated with movement of a pet toy configured for interaction with an animal, the pet toy comprising a core, a shell, and at least one camera;
controlling, by at least one processing device, at least one motor to move the pet toy on a substantially planar surface based on the control information received from the wireless mobile communication device; and
capturing, by the at least one camera, still or video images of the animal while the animal interacts with the pet toy,
wherein the core comprises the at least one processing device, the at least one transceiver, and the at least one motor.
wherein the shell at least partially surrounds and protects the core, the shell formed of a rigid plastic material, the shell configured to be removable from the pet toy without damage to the core.

14. The method of claim 13, further comprising:
receiving, by the at least one transceiver, a movement instruction from the wireless mobile communication device, the movement instruction comprising at least one direction; and
in response to the received movement instruction, controlling, by the at least one processing device, the at least one motor to move the pet toy in the at least one direction.

15. The method of claim 14, further comprising connecting to a local wireless network using the at least one transceiver;
wherein the received information comprises real-time control information associated with the movement of the pet toy that is received from a remote location via the local wireless network.

16. The method of claim 15, further comprising:
transmitting, by the at least one transceiver, the still or video images to the wireless mobile communication device for output to a display of the wireless mobile communication device.

17. The method of claim 15, further comprising:
receiving, by at least one microphone disposed on or in the pet toy, sound from areas around the pet toy while the animal interacts with the pet toy; and
transmitting, by the at least one transceiver, sound data associated with the received sound to the wireless mobile communication device for output to a speaker of the wireless mobile communication device.

18. The method of claim 15, further comprising:
emitting, by at least one speaker disposed on or in the pet toy, voice sounds transmitted from the wireless mobile communication device.

19. The method of claim 15, wherein the rigid plastic material comprises polycarbonate.

20. A non-transitory computer readable medium containing instructions that, when executed by at least one processing device, cause the at least one processing device to:
receive information from a wireless mobile communication device, the received information comprising control information associated with movement of a pet toy configured for interaction with an animal, the pet toy comprising a core, a shell, and at least one camera;
control at least one motor to move the pet toy on a substantially planar surface based on the control information received from the wireless mobile communication device; and
control the at least one camera to capture still or video images of the animal while the animal interacts with the pet toy;
wherein the core comprises the at least one processing device, at least one transceiver, and the at least one motor;
wherein the shell at least partially surrounds and protects the core, the shell formed of a rigid plastic material, the shell configured to be removable from the pet toy without damage to the core.
